(19) United States
(12) Patent Application Publication
(10) Pub. No.: US 2023/0186878 A1
(43) Pub. Date: Jun. 15, 2023

(54) VEHICLE SYSTEMS AND RELATED METHODS

(71) Applicant: Trip Lab, INC., Healdsburg, CA (US)

(72) Inventor: Alex Wipperfürth, San Francisco, CA (US)

(21) Appl. No.: 18/168,284

(22) Filed: Feb. 13, 2023

Related U.S. Application Data
(63) Continuation-in-part of application No. 16/516,061, filed on Jul. 18, 2019, now Pat. No. 11,580,941.
Application No. 16/516,061 is a continuation-in-part of application No. 16/390,931, filed on Apr. 22, 2019.
(60) Provisional application No. 62/661,982, filed on Apr. 24, 2018.

(51) Int. Cl. G10H 1/00; G06F 3/16; G06F 3/0481

(52) U.S. Cl. CPC G10H 1/0008; G06F 3/165; G06F 3/0481; G10H 2240/131; G10H 2210/125; G10H 2210/066; G10H 2210/036; G10H 2210/061; G10H 2210/081; G10H 2210/076

(57) ABSTRACT

Vehicle machine learning methods include providing one or more computer processors communicatively coupled with a vehicle. Using data gathered from biometric sensors and/or vehicle sensors, a machine learning model is trained to determine a mental state of a driver and/or a driving state corresponding with a portion of a trip. In implementations the mental or driving state may be determined without a machine learning model. Based at least in part on the determined mental state and the determined driving state, one or more interventions are automatically initiated to alter the mental state of the driver. The interventions may include preparing (or modifying) and initiating a music playlist, altering a lighting condition within the vehicle, altering an audio condition within the vehicle, altering a temperature condition within the vehicle, and initiating, altering, or withholding conversation from a conversational agent. Vehicle machine learning systems perform the vehicle machine learning methods.

### CROSS REFERENCE TO RELATED APPLICATIONS

This document is a continuation-in-part of U.S. Nonprovisional patent application Ser. No. 16/516,061, entitled “Music Compilation Systems And Related Methods,” naming as first inventor Alex Wipperfürth, which was filed on Jul. 18, 2019, which in turn is a continuation-in-part application of U.S. Nonprovisional patent application Ser. No. 16/390,931, entitled “Vehicle Systems and Interfaces and Related Methods,” naming as first inventor Alex Wipperfürth, which was filed on Apr. 22, 2019, which in turn claims the benefit of the filing date of U.S. Provisional Patent Application No. 62/661,982, entitled “Supplemental In-Vehicle (Passenger and Lifestyle Focused) System and Interface,” naming as first inventor Alex Wipperfürth, which was filed on Apr. 24, 2018, the disclosures of each of which are incorporated entirely herein by reference, and each of which are referred to hereinafter as “Parent applications.”

### BACKGROUND

### 1. Technical Field

Aspects of this document relate generally to machine learning systems and methods for improving traveler wellbeing and/or safety through various mechanisms including music compilation and playback, a conversation agent, and in-vehicle physical conditions. Other aspects related to elements for improving traveler wellbeing and/or safety which do not rely on machine learning.

### 2. Background Art

Conversation agents generally, such as chatbots, exist in the art. Manual controls for in-vehicle physical conditions (such as temperature and lighting) exist in the art. Preexisting NEST thermostats use a machine learning (ML) model for adjusting thermostat settings within a home or building. Various music compilation systems, generally, exist in the art. Some music compilation systems utilize mobile device applications and/or website interfaces for allowing a user to stream music which is stored in a remote database or server. Some existing music compilation systems allow a user to download music in addition to streaming. Traditional methods of determining which songs to include in a compilation include selecting based on musical genre and/or similarities between the songs themselves.

### SUMMARY

Embodiments of vehicle methods may include: providing one or more computer processors communicatively coupled with a vehicle; using the one or more computer processors, determining a mental state of a driver based at least in part on data gathered from one of biometric sensors and vehicle sensors; using the one or more computer processors and based at least in part on one or more details of a trip, determining one of a plurality of predetermined driving states corresponding with at least a portion of the trip; and using the one or more computer processors, and based at least in part on the determined mental state and the determined driving state, automatically initiating one or more interventions configured to alter the mental state of the driver.

Embodiments of vehicle methods may include one or more or all of the following:

The plurality of predetermined driving states may include observant driving, routine driving, effortless driving, and transitional driving.

The one or more processors may determine that at least a portion of the trip includes observant driving in response to a detection or determination that one or more of the following are present or upcoming: a traffic slowdown of a predetermined threshold below a speed limit; a calculated traffic jam factor beyond a predetermined threshold; rain; snow; fog; wind speed above a predetermined threshold; temperature beyond a predetermined threshold; driving between a predetermined time range; driving during a predetermined rush hour time range; driving a threshold amount beyond a speed limit; a structural obstruction; a toll location; light conditions beyond a predetermined threshold; a driving location the driver has not previously traversed; and a driving location the driver has traversed below a predetermined amount of times.

The one or more processors may determine that at least a portion of the trip includes routine driving in response to a detection or determination that one or more of the following are present or upcoming: a total estimated travel time below a predetermined time limit; a driving location the driver has previously traversed; a driving location the driver has previously traversed a threshold number of times; a total trip mileage below a predetermined threshold; mileage of a portion of the trip below a predetermined threshold; time of a portion of the trip being below a predetermined threshold; a commute to work; absence of rain; absence of snow; absence of fog; wind speed below a predetermined threshold; light conditions beyond a predetermined threshold; and a drop off of a passenger.

The one or more processors may determine that at least a portion of the trip includes effortless driving in response to a detection or determination that one or more of the following are present or upcoming: a commute having an expected mileage above a predetermined threshold; a commute having an expected travel time above a predetermined threshold; traveling on a highway; traveling on a freeway; traveling on an interstate; a total expected travel time beyond a predetermined amount of time; expected travel time for a trip portion being beyond a predetermined amount of time; a driving location the driver has previously traversed; a driving location the driver has previously traversed a threshold number of times; a vacation-related trip; an absence of a traffic slowdown of a predetermined threshold below a speed limit; a calculated traffic jam factor within a predetermined threshold; an absence of structural obstructions; a lack of toll locations; absence of rain; absence of snow; absence of fog; temperature above a predetermined threshold; temperature within a predetermined range; temperature below a predetermined threshold; wind speed below a predetermined threshold; light conditions beyond a predetermined threshold; driving within a predetermined time range; a consistent speed limit for a predetermined amount of time or mileage; and driving outside of a predetermined rush hour time range.

The one or more processors may determine that at least a portion of the trip includes transitional driving in response to a detection or determination that one or more of the following are present or upcoming: a commute home; an estimated amount of time, to a determined end location from a present location, below a predetermined threshold; an estimated amount of mileage, to a determined end location from a present location, below a predetermined threshold; and a determination of a different activity type at the end location relative to an activity type at a starting location.

The one or more processors may default to the routine driving state unless one or more characteristics of observant driving, effortless driving, or transitional driving are detected or determined, or unless a commute home is detected or determined.

Embodiments of vehicle machine learning methods may include: providing one or more computer processors communicatively coupled with a vehicle; using data gathered from one of biometric sensors and vehicle sensors, training a machine learning model to determine a mental state of a driver; determining the mental state of the driver using the trained machine learning model; using the one or more computer processors and based at least in part on one or more details of a trip, determining one of a plurality of predetermined driving states corresponding with at least a portion of the trip; and using the one or more computer processors, and based at least in part on the determined mental state and the determined driving state, automatically initiating one or more interventions configured to alter the mental state of the driver.

Embodiments of vehicle machine learning methods may include one or more or all of the following:

The one or more computer processors may determine the driving state based at least in part on a location of the vehicle.

The plurality of predetermined driving states may include observant driving, routine driving, effortless driving, and transitional driving.

The one or more interventions may include changing an environment within a cabin of the vehicle.

The one or more interventions may include one of altering a lighting condition within the cabin, altering an audio condition within the cabin, and altering a temperature within the cabin.

The one or more interventions may include one of preparing a music playlist and altering the music playlist, and the one or more interventions may further include initiating the music playlist.

The one or more interventions may include selecting music for playback within the cabin.

The one or more computer processors may select the music based at least in part on an approachability of the music, an engagement of the music, a sentiment of the music, and an energy of the music or a tempo of the music.

The one or more interventions may include initiating, altering, and/or withholding interaction between the driver and a conversational agent.

Training the machine learning model to determine the mental state of the driver may include training the machine learning model to determine a valence level, an arousal level, and/or an alertness level of the driver.

Initiating the one or more interventions to alter the mental state of the driver may include initiating one or more interventions to alter a valence level, an arousal level, and/or an alertness level of the driver.

Embodiments of vehicle machine learning systems may include: one or more computer processors; and one or more media storing instructions executable by the one or more processors, wherein the instructions, when executed, cause the vehicle machine learning system to perform operations including: training a machine learning model to determine one of a plurality of predetermined driving states corresponding with at least a portion of a trip; determining one of the predetermined driving states corresponding with at least a portion of the trip using the trained machine learning model; based at least in part on data gathered from biometric sensors and/or vehicle sensors, determining a mental state of a driver; and based at least in part on the determined mental state and the determined driving state, automatically selecting and initiating one or more interventions configured to alter the mental state of the driver.

Embodiments of vehicle machine learning systems may include one or more or all of the following:

The one or more interventions may be selected based at least in part on a target brainwave frequency.

General details of the above-described embodiments, and other embodiments, are given below in the DESCRIPTION, the DRAWINGS, and the CLAIMS.

### BRIEF DESCRIPTION OF THE DRAWINGS

Embodiments will be discussed hereafter using reference to the included drawings, briefly described below, wherein like designations refer to like elements:

FIG. 1 is a diagram view of an implementation of a vehicle system;

FIG. 2 is a front view of a vehicle dashboard having a display on which user interfaces of the system of FIG. 1 may be displayed;

FIG. 3 is a block diagram of a subset of elements of the system of FIG. 1 which may exist in or on a vehicle;

FIG. 4 is a block diagram representatively illustrating relationships between elements, and methods associated with elements, of the system of FIG. 1;

FIG. 5 is a block diagram representatively illustrating example processes implemented by the system of FIG. 1;

FIG. 6 is a diagram of an example user interface of the system of FIG. 1;

FIG. 7 is a diagram of another example user interface of the system of FIG. 1;

FIG. 8 is a diagram of another example user interface of the system of FIG. 1;

FIG. 9 is a diagram of another example user interface of the system of FIG. 1;

FIG. 10 is a diagram of another example user interface of the system of FIG. 1;

FIG. 11 is a diagram of another example user interface of the system of FIG. 1;

FIG. 12 is a flowchart representatively illustrating an example of a wayfinding method implemented using the system of FIG. 1;

FIG. 13 is a table representatively illustrating elements of the example music compilation method of FIG. 21 which is implemented using the system of FIG. 1;

FIG. 14 is a table representatively illustrating other elements of the example music compilation method of FIG. 21;

FIG. 15 is a set of tables representatively illustrating elements of the example music compilation method of FIG. 21;

FIG. 16 is a diagram representatively illustrating elements of the example music compilation method of FIG. 21;

FIG. 17 is a diagram representatively illustrating elements of the example music compilation method of FIG. 21;

FIG. 18 is a diagram representatively illustrating elements of the example music compilation method of FIG. 21;

FIG. 18A is a diagram representatively illustrating music compilation elements implemented using the system of FIG. 1;

FIG. 18B is a diagram representatively illustrating music compilation elements implemented using the system of FIG. 1;

FIG. 18C is a diagram representatively illustrating music compilation elements implemented using the system of FIG. 1;

FIG. 18D is a diagram representatively illustrating music compilation elements implemented using the system of FIG. 1;

FIG. 19 is a diagram representatively illustrating elements of the example music compilation method of FIG. 21;

FIG. 20 is a diagram representatively illustrating elements of the example music compilation method of FIG. 21;

FIG. 21 is a flowchart representatively illustrating an example music compilation method implemented using the system of FIG. 1;

FIG. 22 is a flowchart representatively illustrating an example method of implementing an interactive chatbot using the system of FIG. 1;

FIG. 23 is a block diagram representatively illustrating example vehicle sensors referenced in FIG. 3;

FIG. 24 representatively illustrates an environment of use of the system of FIG. 1 in which the system determines a distracted state of a driver and initiates a safety alert;

FIG. 25 representatively illustrates data that may be gathered by various sensors of the system of FIG. 1 and determinations the system of FIG. 1 may make using such data; and

FIG. 26 representatively illustrates various interventions implemented using the system of FIG. 1 based on various states of driving.

### DESCRIPTION

Implementations/embodiments disclosed herein (including those not expressly discussed in detail) are not limited to the particular components or procedures described herein. Additional or alternative components, assembly procedures, and/or methods of use consistent with the intended vehicle systems and interfaces and related methods may be utilized in any implementation. This may include any materials, components, sub-components, methods, sub-methods, steps, and so forth.

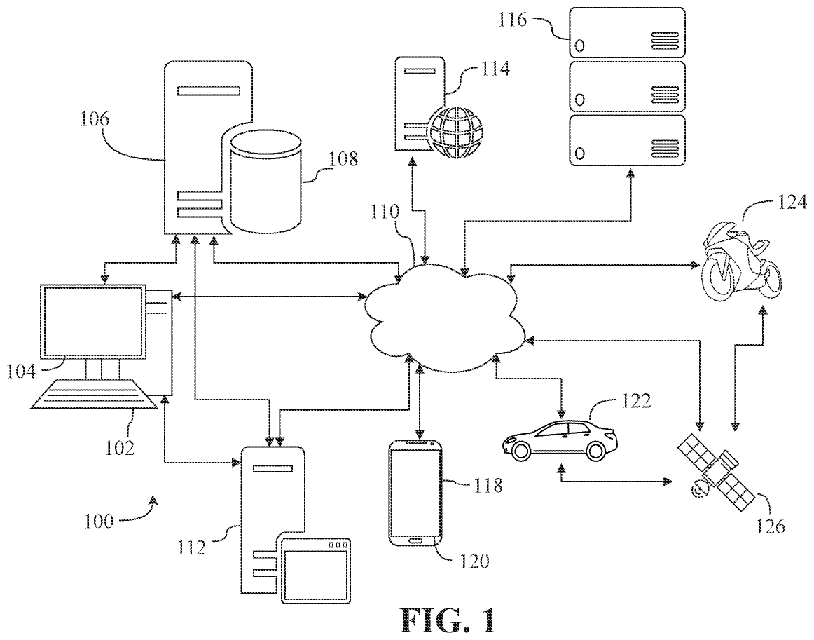

Referring now to FIG. 1, a representative implementation of a vehicle system (system) 100 is shown. Other vehicle systems may include additional elements and/or may exclude some elements of system 100, but some representative example elements of system 100 are shown. Computing device (device) 102 includes a display 104 through which an administrator may access various elements of the system using a variety of user interfaces. Device 102 is seen communicatively coupled with a database server (DB server) 106 which in turn is communicatively coupled with a database (DB) 108. The administrator may configure one or more databases and one or more database servers for storing various data used in conjunction with the methods disclosed herein.

The administrator device 102 may be directly communicatively coupled with the database server or could be coupled thereto through a telecommunications network 110 such as, by non-limiting example, the Internet. The admin and/or travelers (end users) could access elements of the system through one or more software applications on a computer, smart phone (such as device 118 having display 120), tablet, and so forth, such as through one or more application servers 112. The admin and/or end users could also access elements of the system through one or more websites, such as through one or more web servers 114. One or more off-site or remote servers 116 could be used for any of the server and/or storage elements of the system.

One or more vehicles are communicatively coupled with other elements of the system, such as vehicles 122 and 124. Vehicle 122 is illustrated as a car and vehicle 124 as a motorcycle but representatively illustrate that any vehicle (car, truck, SUV, van, motorcycle, etc.) could be used with the system so long as the vehicle has a visual and/or audio interface and/or has communicative abilities through the telecommunications network through which a traveler may access elements of the system. A satellite 126 is shown communicatively coupled with the vehicles, although the satellite may rightly be understood to be comprised in the telecommunications network 110, only to emphasize that the vehicles may communicate with the system even when in a place without access to Wi-Fi and/or cell towers (and when in proximity of Wi-Fi and/or cell towers may also communicate through Wi-Fi and cellular networks).

The system 100 is illustrated in an intentionally simplified manner and only as a representative example. One or more of the servers, databases, etc. could be combined onto a single computing device for a very simplified version of system 100, and on the other hand the system may be scaled up by including any number of each type of server and other element so that the system may easily serve thousands, millions, and even billions of concurrent users/travelers/vehicles.

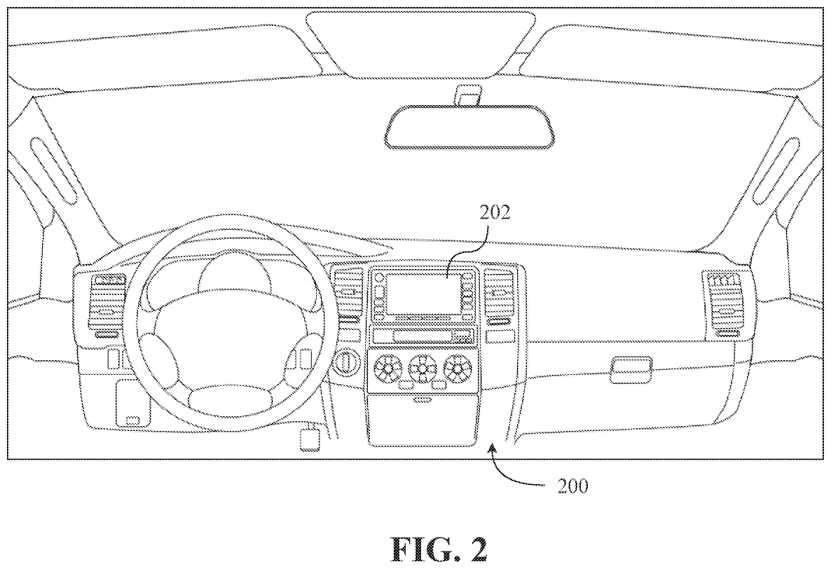

Referring now to FIG. 2, a representative example of a vehicle dashboard (dashboard) 200 is shown, on which a display 202 is located. On a display such as this various user interfaces, enabled by the system 100, may be shown to a traveler, and may be used for visual communications to and from the traveler. In-vehicle audio elements, such as a vehicle microphone to receive user audio input and speakers to communicate and/or provide sound to the user, may also provide user communication with elements of system 100.

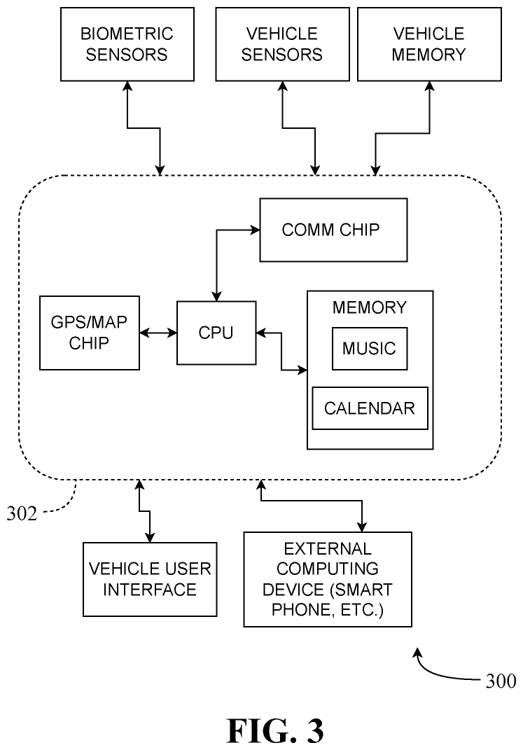

Referring now to FIG. 3, the system 100 may also include elements located within or coupled directly with a vehicle. For example, block diagram 300 shows a representative example of a Trip Brain 302 which includes a central processing unit (CPU), a GPS or map chip, a communications (COMM) chip, and on-board memory. These elements could all be coupled on a single printed circuit board (PCB) and located within the dashboard (or elsewhere on/in the vehicle) communicatively coupled with the display 202 and with the vehicle's audio elements (speakers and microphone, not shown) and biometric sensors which together comprise the vehicle user interface. The Trip Brain may receive input from the vehicle user interface through voice or audio commands, physical button/selector/knob inputs, touchscreen inputs, and so forth. The Trip Brain may send data to the vehicle user interface for visual display and/or audio output to the traveler. A traveler's external computing device (smart phone, laptop, tablet, etc.) may also send data to, and receive data from, the Trip Brain in like manner over wireless signals such as through Wi-Fi, cellular, BLUETOOTH, or the like using the communications chip.

The communications chip (which in implementations may actually be multiple chips to communicate through Wi-Fi, BLUETOOTH, cellular, near field communications, and a variety of other communication types) may be used to access data stored outside of system 100, for example the user's GOOGLE calendar, the user's PANDORA music profile, and so forth. The communications chip may also be used to access data stored within the system database(s) (which may include data from an external calendar, an external music service, and a variety of other elements/applications that have been stored in the system database(s)). Local memory of the Trip Brain, however, may also store some of this information permanently and/or temporarily.

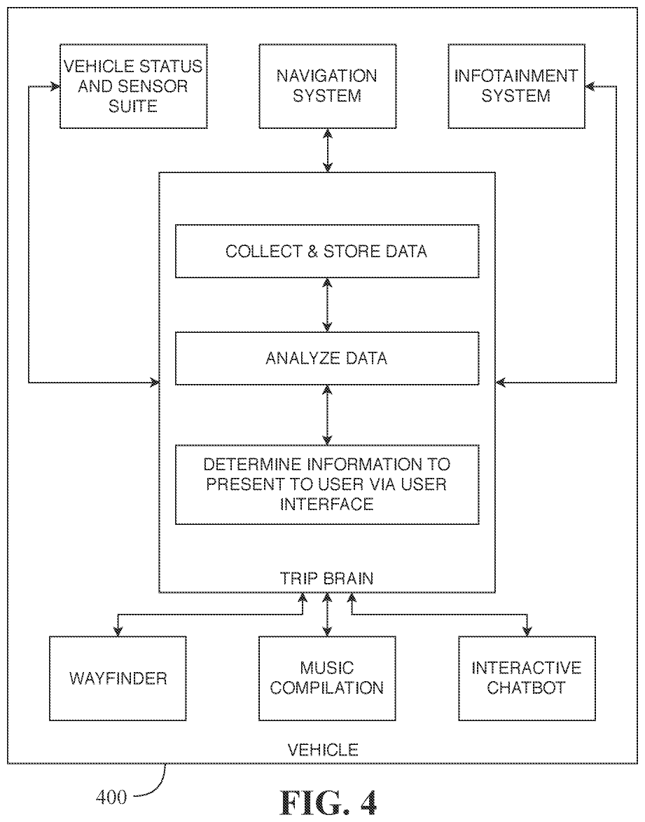

The Trip Brain is also seen to be able to access information from the vehicle sensors and the vehicle memory. In implementations the Trip Brain only receives data/information from these and does not send information to them (other than queries) or store information therein, but as data queries may in implementations be made to them (and to a vehicle navigation system) the arrow connectors between these elements and the Trip Brain in FIGS. 3-4 are illustrated as two-way connectors. Similarly, as the Trip Brain may receive input from users through one or more Wayfinder interfaces, one or more Music Compilation interfaces, and or through user interaction with the Interactive Chatbot, as will be discussed more below, the arrows connecting those elements with the Trip Brain in FIG. 4 are also shown as two-way connectors.

The Trip Brain may include other connections or communicative couplings between elements, and may include additional elements/components or fewer components/elements. Diagram 300 only shows one representative example of a Trip Brain and its connections/communicative couplings with other elements. In some implementations some processing of information could be done remote from the vehicle, for example using an application server or other server of system 100, so that the Trip Brain is mostly used only to receive and deliver communications to/from the traveler. In other implementations the Trip Brain may include greater processing power and/or memory/storage for quicker and local processing of information and the role of external servers and the like of system 100 may be reduced.

Referring now to FIG. 4, block diagram 400 representatively illustrates in more detail the functionality of the Trip Brain. This functionality includes, in implementations, data collection, analysis, and management. The Trip Brain allows for every kind of trip to be its own unique type of experience determined by the specific qualities of the trip. By non-limiting example, in implementations there are six major contextual qualities that may define a trip, and the Trip Brain may, using user input (directly acquired from user input and/or passively acquired by system listening, including through biometric, speech, facial recognition and other sensors) and/or acquired by the system accessing information externally (such as through Internet information sources, GPS data, and so forth), structure the experience accordingly. In such implementations the six qualities are:
(1) Trip progression: How will the drive evolve? How long will the trip be? What kinds of roads will be driven on and will the type of road change (i.e., from city to highway)? Will there be traffic jams? Toll roads, etc.
(2) Intent, the purpose of the trip: Is it a commute, an errand, a trip to a meeting, a road trip?
(3) The social dynamic within the cabin: Is the driver alone, traveling with family, with friends, with weak social connections? The driver's experience will be dramatically different depending on the context.
(4) The driver's or traveler's state of mind: Is the driver reflective? Frustrated? Does she/he/they need to reboot their brain?
(5) The trip conditions: What is the weather like outside? What is the time of day? What are the speeds of travel?
(6) Regularity of the trip: Is the trip part of a larger pattern? Is it a recurring, even regular trip? Is there a time and/or day of week (e.g., only on Saturdays) pattern to it? Are there certain behaviors associated with this particular route, like stopping for a coffee or gas? Are routine choices being made?

FIG. 4 shows the navigation system existing outside of the Trip Brain, and indeed this is an option different than what was presented in FIG. 3. The vehicle may already have its own GPS chip and/or navigation system, and the Trip Brain may simply communicate with the existing navigation system as shown in FIG. 4.

FIG. 4 also shows that the Trip Brain collects and stores data. In implementations the information provided by the car's sensors and other vehicle information is accumulated over time by the Trip Brain in order to assess the aforementioned qualities of context. This data input is precise and manageable as it is derived only from concrete sources available to the car system. For example, in the example of FIG. 4 a navigation application is already able to present the last destination entered, store destinations, and so on. The Trip Brain, however, also combines, tracks and analyzes the information so that it can learn and adjust based on previous behavior and so that the same information can be used in other services and applications, not only in the app from which it was sourced. In other words, the accumulated data collected is shared among various applications and services instead of being isolated. The storage half of “Collect & Store” may include storage in local memory and/or storage remotely, by accessing storage elements communicatively coupled with the Trip Brain through the telecommunications network.

FIG. 4 also shows that the Trip Brain does data analysis. Each trip may contain data from various sources including the vehicle's sensors and other vehicle information, the navigation application, the infotainment system, connected external devices (laptop, smart phone, etc.), and so on. The Trip Brain synthesizes the information in order to make inferences about the qualities of context that define a trip.

In implementations the trip progression can be derived from the navigation system.

In implementations intent can be derived by analyzing the cumulative historical information collected from the navigation system (e.g., the number of times a particular destination was used, the times of day of travel, and the vehicle occupants during those trips) as well as the traveler's calendar entries and other accessible information.

In implementations the social dynamic in the car can be deduced by the navigation (e.g., type of destination), the vehicle's voice and face recognition sensors, biometric sensors, the infotainment selection or lack thereof, the types and quantity of near field communication (NFC) objects recognized (e.g., office keycards), and so on.

In implementations the occupants' state of mind can be determined via the vehicle's biometric, voice and face recognition sensors, the usage of the climate control system (e.g., heat), infotainment selection or lack thereof, and so on. For example, a driver of the vehicle may be in a bad mood (as determined by gripping the steering wheel harder than usual and their tone of voice, use of language, or use of climate control system) and may be accelerating too quickly or driving at a high speed. The system may be configured to provide appropriate feedback to the driver responsive to such events.

In implementations the road conditions can be sourced through the car's information and monitoring system (e.g., speedometer, external sensors, weather app, the navigation system and the Wayfinder service, which will be explained in detail below).

In implementations regularity of the trip can be determined through cumulative historical navigation data, calendar patterns, and external devices that may be recognized by the vehicle (e.g., personal computer).

In implementations the Trip Brain analyzes each data point relating to a particular trip and provides direction for the Wayfinder, Music Compilation, and Interactive Chatbot features. These features are implemented through the one or more vehicle user interfaces (presentation layer) in a way that is cohesive, intuitive and easy to understand and use. In implementations (as in FIG. 4) the Trip Brain may interact with an existing infotainment system present in a vehicle, such as by non-limiting example by obtaining information and/or entertainment material through the infotainment system to present to the travelers through the AI Sidekick or otherwise. As an example the Trip Brain may obtain from the infotainment system a list of news stories, pop-culture events, and so forth and the Interactive Chatbot may present these to the travelers and ask if they are interested in knowing more about any given one, and if so may proceed to give more information related thereto.

In implementations the Trip Brain and the system 100 architecture are based on system design thinking rather than just user design thinking. As a result, it offers a comprehensive service that is not only designed for individual actions, but considers the entire experience as a coherent service that considers each action as part of the whole. Consider, for example, the audio aspect of infotainment. One possible alternative to streaming music sequentially is to render it in a manner similar to a DJ mix: having a beginning, a middle, and an end, and sometimes playing only parts of songs instead of complete tracks. The characteristics of the mix (e.g., sentiment) may be based on the attributes of the trip (e.g., intent). To accomplish this the Trip Brain may acquire and store information from the vehicle navigation system to let the music app know, via the Trip Brain, the context associated with the trip such as duration, intent, social dynamic, road conditions and so on. If the Trip Brain has information from the navigation system and calendar indicating the driver of the vehicle is heading to a business meeting at a new location, the vehicle interface system can, using the Interactive Chatbot, prompt the driver fifteen minutes before arrival and provide the driver with the meeting participants' bios to orient the driver for the visit.

As indicated by FIGS. 3-4, in implementations there is a symbiotic connectivity between the different vehicle systems through the Trip Brain. For example, the Trip Brain may receive input from the vehicle navigation system, infotainment system (music/telematics), car sensors, a calendar or planner associated with a user of the vehicle that may be a part of the infotainment system, outside sources (like a smart phone), and other vehicle information such as type of vehicle, weight, and so forth, all managed and interpreted by the Trip Brain and turned into actionable directives for the Wayfinder, Music Compilation, and Interactive Chatbot services, and delivered to the user through one or more user interfaces.

The system and methods provide an intelligent in-vehicle experience that supplements the existing vehicle features. The intelligent in-vehicle experience is based on data collection, analysis, and management and integrates the different components of the driver-vehicle interface. The Wayfinder, Music Compilation, and Interactive Chatbot features, discussed further below, are presented to the driver in a cohesive, intuitive format that is easy to understand and use. This intelligent vehicle experience may in implementations (and herein may) be referred to as “TRIP.” The Trip Brain reads inputs from the car's navigation application and other input sources such as weather, calendar, etc. that are configured to provide location coordinates and other trip-related information to the vehicle interface. This information is used by the Trip Brain to direct Wayfinding, Music Compilation, and Interactive Chatbot (wellbeing and productivity) functions.

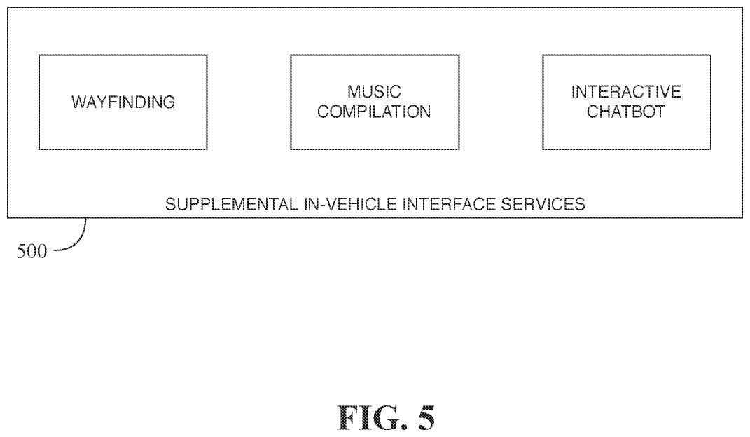

Referring now to FIG. 5, block diagram (diagram) 500 representatively illustrates that, in some implementations, the functionality of the system 100 and/or Trip Brain may be broadly organized into three categories: Wayfinding (which is more than mere navigational mapping, and which may be referred to as “Wayfinder”); DJ-like Music Compilation (which may be referred to as “Soundtrack”); and an artificial intelligence (AI) Interactive Chatbot (which may be referred to as “Sanctuary”). These services are distinct from what exists in current vehicle systems, and are accordingly designated “supplemental” in FIG. 5. Each of these functions may be used discretely in implementations, and in implementations they may all also be interconnected.

In implementations the Wayfinding, Music Compilation, and Interactive Chatbot experience allow the car cabin to function as a unique “in-between” or “task-negative” space (as opposed to an on-task space such as the workplace or the home) that lets travelers' minds wander, helps them emotionally reset, and serves as a sanctuary and a place of refuge. The Wayfinding, Music Compilation, and Interactive Chatbot features will be discussed on more detail below.

Wayfinding Service

The Wayfinding service (Wayfinder) may be implemented using one or more user interfaces that are displayed on display 202, but is more than a navigational map. While conventional navigational maps serve the driver operating a car with route selection, turn-by-turn directions and distances (e.g., number of miles to the next turn), the Wayfinder serves the passenger's trip-related orientation and activities for life outside the car. It exists to help people along a drive, enhance their understanding and enrich their experience of the route and destination. Additionally, the Wayfinding service provides flexibility in the visual presentation and organization of the map, allowing for infographic (or more infographic) as opposed to cartographic (or primarily cartographic) presentation. For example, in implementations distracting and static street grid elements are removed. In implementations the Wayfinding service may focus more on showing the user's traveling times or time ranges, as opposed to distances, involved in a given route. In these ways, the Wayfinding service conveys trip information in a way that is easier to understand (e.g., time instead of distance) and uses a design element herein termed “Responsive Filtering,” in that information not pertinent to a passenger's question at hand (i.e., miles, street grid layout, etc.) are removed to avoid overload.

In implementations, before beginning a trip, the Wayfinding service may present an animated three-dimensional suggested route for the driver, or a route selected by the driver, to orient the driver and give a sense of the trip ahead. This feature is called “Trip Preview.” In implementations the system may, using the AI Sidekick/Interactive Chatbot, narrate an overview of the trip to the driver synchronous with the animation, providing information that includes expected duration of trip, route, weather conditions, road conditions, traffic along the way, and so forth. The system may also provide information about weather conditions at the destination.

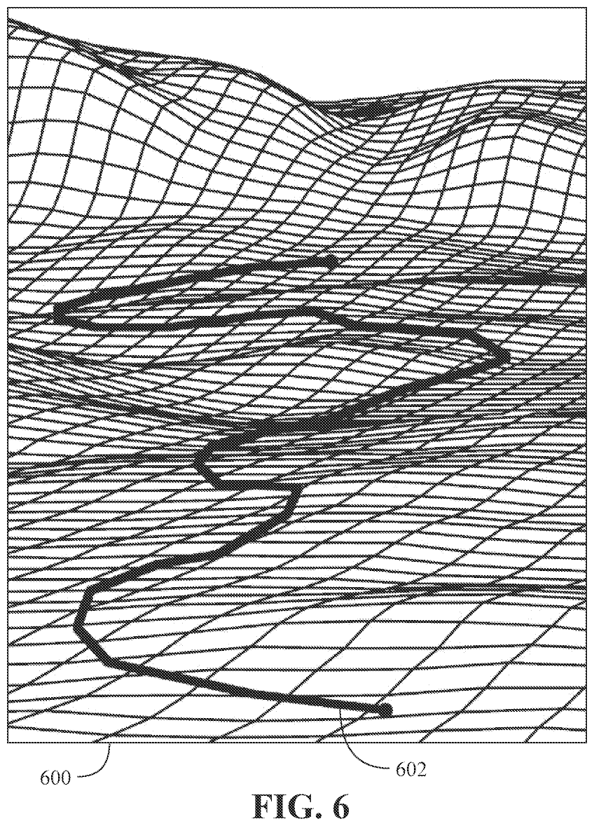

FIG. 6 shows a representative example of an interface 600 that may be displayed to the driver using the display 202, and illustrates an example of a single frame from an animated three-dimensional rendition of the trip that may be displayed to the driver. FIG. 6 shows three-dimensional landscape with grid-like texture to show elevation, but this is only one representative example. The landscape may be shown as an animation of actual natural-looking or photographic-like (or video-like) representations of features such as hills, rivers, lakes, cities, towns, canyons, bridges, and so forth. In implementations a user may be able to zoom in and out with commands (in implementations touch-screen commands), rotate the view, toggle between optional paths/routes, exit the view, and so forth. FIG. 6 shows a path 602, for example, that starts with a beginning near the bottom of the page and ends at an ending place nearer the top of the page. In implementations the user could toggle between this path/route and other paths/routes as desired before selecting which route to take. In implementations the driver may make edits to any given path or route to make modifications to it before beginning the trip. Such changes to individual routes, and toggling between routes, may in implementations also be done during the trip. Accordingly, while interface 600 may show a preview of a trip, it may also be displayed whenever desired during a trip to see trip progress from a three-dimensional landscape perspective. The path 602 or route is shown as a solid line, but it may be illustrated in any manner, such as a dotted line, a line of any color, and so forth.

In implementations the visual shown on interface 600 is more of a flyover visual, such as a visual similar to those used by the STRAVA route builder or by the GOOGLE MAPS interface, which in implementations may be a dynamic aerial presentation to the traveler which shows the route starting from beginning and moving the visual to the end of the trip in an animated fashion. In implementations the system may interface with STRAVA or GOOGLE MAPS APIs, or other APIs, to provide the dynamic visuals to the traveler.

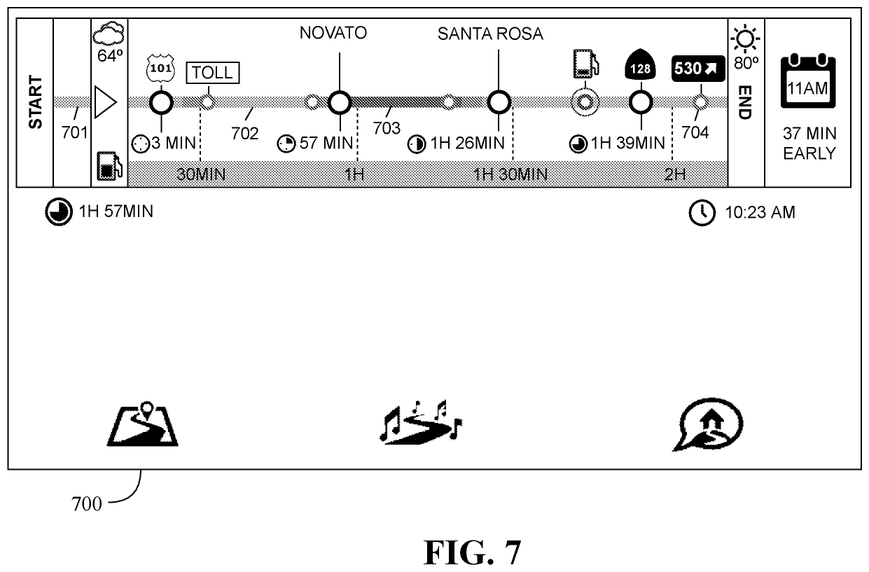

FIG. 7 shows a representative example of another interface of the system 100, which in implementations may be called the Tracker or Trip Tracker. This interface may be shown on display 202 and may in implementations show a summary of the trip at hand. The summary is visually displayed in a way that a short glance gives the user an updated sense of the trip, relative to his/her current location along the route. The Trip Tracker does not replace the navigational applications provided by car systems or external devices but rather complements them. In implementations the Trip Tracker is a permanent and dynamic resident of the car dashboard, for example being by default displayed on display 202 during a trip. It is the visual infographic representing each drive, conveying key information and progress within one quick glance such as a timeline, waypoints, and other features/details of a trip.

The Trip Tracker interface in implementations includes selectors that are selectable to expand (to provide further detail) and/or to navigate to other windows/interfaces. As seen in FIG. 7, the bottom of the infographic display presents three icons. The leftmost icon is an icon that initiates the Wayfinder service. The middle icon is associated with the Music Compilation service (discussed subsequently) called Soundtrack, and the rightmost icon represents the Interactive Chatbot, which may be called Sanctuary, discussed more below.

The top part of FIG. 7 shows an infographic associated with a trip. Here, a driver wishes to drive from San Francisco, Calif., to Yorkville, Calif., for a meeting. The infographic displays the temperature at the starting location. The infographic indicates that the driver has already started the trip and will travel on the 101 freeway three minutes from the current time. The band at the lower part of the infographic shows a timeline, demarking 30-minute intervals in this instance (time intervals in implementations would depend on the duration of a particular trip). Important aspects of the trip such as a use of a toll road and a need to fill gas or recharge the vehicle are also displayed on the infographic. Important waypoints, such as Novato and Santa Rosa in this example which have clusters of businesses and services, may be displayed on the infographic, with the approximate time at which the driver is expected to reach those waypoints. In this example, the driver is expected to reach Novato in 57 minutes, and Santa Rosa in 1 hour and 26 minutes. After approximately 1 hour and 39 minutes, the route suggests that the driver stop for gas before merging onto the 128 freeway and exiting towards the destination. Based on existing conditions and the current location, the driver is expected to reach the destination in 1 hour and 57 minutes from the point shown in the Trip Tracker, at approximately 10:23 AM, or 37 minutes early for an 11 am appointment. The infographic may also display the anticipated temperature at the destination, which may change during the trip based on updated information. In implementations, while the traveler is en route the column shown in FIG. 7 containing the weather, temperature, triangle and fuel/charge icon will move along the trip tracker interface and the contents of the column (e.g., weather) may change due to current conditions. In implementations, if the traveler arrives at his/her destination with time to spare, the AI chatbot may proactively suggest ways to spend the time. In this example, the AI chatbot may suggest reviewing names, backgrounds, etc., of the meeting attendees or the AI chatbot may suggest a timely detour to use the restroom and otherwise physically prepare for the calendar event.

The information displayed on the infographic is generally dynamically updated in real-time based on current conditions, to include weather and traffic. This may be done, for example, by the Trip Brain or other elements of the system periodically querying databases or Internet information related to weather, road conditions, and so forth. As a non-limiting example, the Trip Brain and/or other elements of the system could access road conditions, weather conditions, gas prices, electric vehicle charging stations and related prices (as appropriate), toll amounts, and so forth by communicating with third-party programs and tools through application programming interfaces (APIs). If done by the Trip Brain the one or more elements of the Trip Brain could directly access information through one or more third-party APIs, or alternatively the Trip Brain could communicate with one or more servers of the system 100 that itself obtains/updates such information using third-party APIs, or the system 100 could regularly update a database with such information using third party APIs so that the Trip Brain can update the information on the infographic by regularly querying the database for road conditions, weather, and so forth relevant to the specific trip.

During the trip, the AI assistant may offer audio prompts to the driver on an ongoing basis regarding upcoming events, such as a toll road, a need to change freeways, a need to fill gas, suggest a rest stop (e.g., after a prolonged period in the car) and so on. Using an infographic system in this way avoids information overload for the driver, allowing the driver to instantly comprehend the information and quickly and easily make informed decisions.

Other elements of the infographic are useful to provide quick information to the user. For example: the weather at each the beginning and ending locations may also be represented by an icon (clouds, rain, snow, sunny); the various highways, toll roads, freeways, entrances, exits, etc. may be represented by icons which are indicative of the type of road or event; weather conditions could be shown for intermediate towns/cities; gas and/or charge icons may be represented as more filled, half filled, less filled (similar to those shown in FIG. 7) to indicate an expected gas tank or charge level, and so forth. The line shown at the middle of the infographic that runs horizontally from the start location to the end location is also seen to have various shades to represent traffic conditions, for example darker for slower traffic conditions or traffic jams, and lighter for less traffic and slowing. In implementations these could be represented with different colors, such as gray for no slowing, orange for some slowing, and red for more severe slowing, as representative examples. Useful colors may be used for other things, like red for more important events (such as a red gas icon for a more critical need to fill up, a flashing icon for an important event, greed road or highway number signs to match with the actual road or highway signs, and so forth.

In implementations one or more icons of interface 700 may be selectable to bring up more information. There may be an icon on interface 700 which when selected brings up interface 600, previously described. Any of the icons of interface 700 may be selectable to bring up more relevant information about the item represented by the icon, such as weather information brought up in response to touching a weather icon, gas price or location information brought up in response to touching a gas icon, city or town information brought up in response to touching the wording of an intermediate town or city, and so forth.

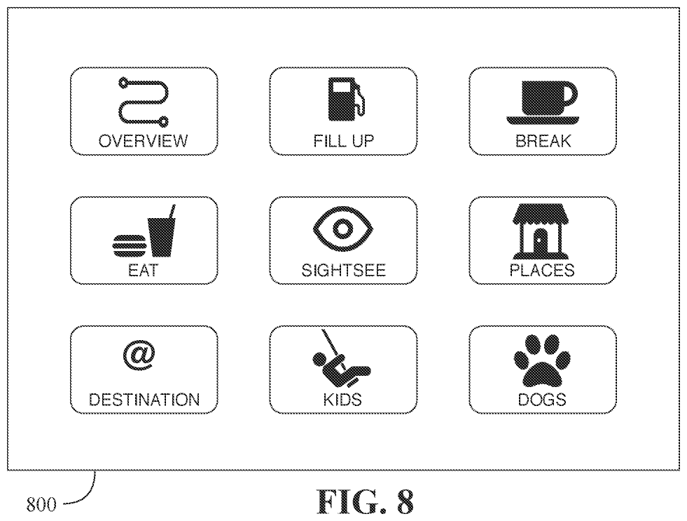

In implementations if a user selects the Wayfinding icon in the bottom left corner of interface 700 the interface 800 of FIG. 8 is displayed on display 202. The Wayfinder service may have several features which will be discussed—these features may be customized and presented to the car occupants based on, for example, car occupants' preferences and the nature of the trip. Interface 800 includes various selectors, having associated icons, which a user may select such as through touch (in the case of a touchscreen display 202) or using a joystick or other navigational mechanism of the display (similar to any other selector described herein). Other Wayfinding options may be available in other implementations, but the options/selectors represented in FIG. 8 are discussed below as representative examples.

Overview: Selecting this selector switches to an infographic view as shown in FIG. 7, providing a time-based overview of the trip with important waypoints. In other words, selecting the overview option provides the travelers with information about what the trip looks like, what they need to be aware of, where they are now, when they will get to the destination, how much time is left, and so on.

Fill Up: Selecting this selector brings up an interface (not shown in the drawings) which indicates appropriate times and places to refuel or recharge the vehicle based on the vehicle status (e.g., level of charge) and location along the route.

Break: Selecting this selector brings up an interface (not shown in the drawings) indicating appropriate places and times to take a break based on, for example, how long the trip has continued uninterrupted. A break could include stopping to stretch, have a coffee break, or use a restroom.

Eat: Selecting this selector brings up an interface (not shown in the drawings) which provides information on restaurants on the way to the destination. In implementations the types of restaurants shown may be those that suit the palettes of the car occupants as determined by prior information gathered from the car occupants.

Sightsee: Selecting this selector brings up an interface (not shown in the drawings) which provides information on any special sights or points of interest to see along the trip.

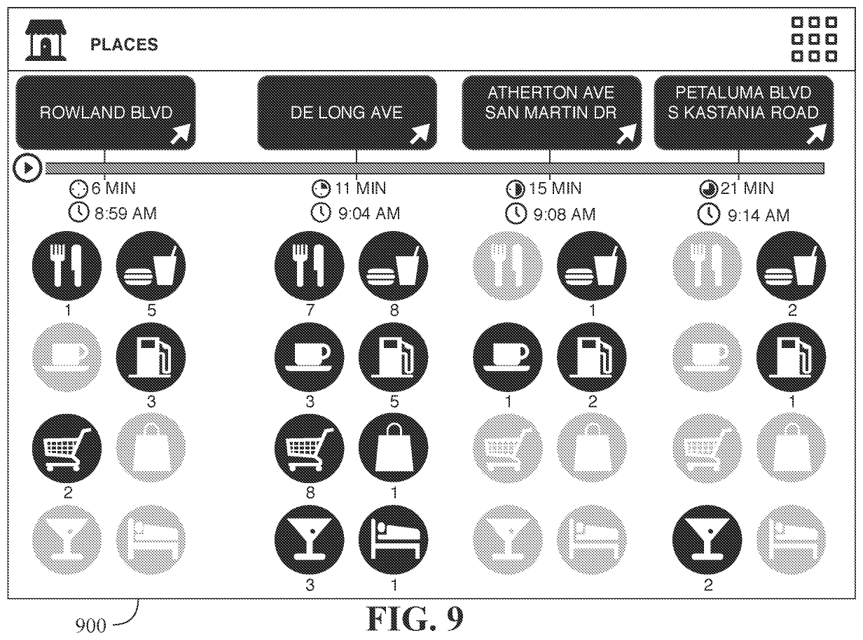

Places: Selecting this selector brings up an interface providing information regarding places could include cities, businesses and so on that are in the vicinity of the travelers at any particular given time. Other information could include a densest cluster of places and services to accomplish more than one task during a stop (e.g., getting a coffee, refueling/recharging and taking a restroom break). A representative example of a Places interfaces is interface 900 shown in FIG. 9 and will be discussed hereafter.

Destination: Selecting this selector brings up an interface (not shown in the drawings) which provides information about the destination (e.g., weather, where to eat, and so on) to give the travelers a good sense of their destination.

Kids: Selecting this selector brings up an interface (not shown in the drawings) which provides information on nearby parks, playgrounds, kid-friendly restaurants and so forth along the trip.

Dogs: Selecting this selector brings up an interface (not shown in the drawings) which provides information about dog-friendly places (e.g., dog parks, places to walk, etc.) if a dog has been brought on the trip.

In implementations the system may show other icons/selectors on interface 800, representing other information, and may include fewer or more selections. In implementations the system may intelligently decide which icons to show based on some details of the trip—for example including the Kids selector if the vehicle microphone picks up a child's voice and the trip is longer than a half hour, including the Dogs icon if the vehicle microphone picks up noises indicative of a dog in the vehicle, excluding the Sightsee selector if the system determines that the traveler does not have time to sightsee and still make it to an appointment in time, and so forth. Any of these intelligent decisions could be made locally by the Trip Brain, or could be made by other elements of the system (such as one or more of the servers communicatively coupled with the Trip Brain through the telecommunications network) and communicated to the Trip Brain. In implementations, the user may decide which icons to show based on preferences—for example excluding the KIDS selector if the user does not have children—that later may be changed by the user or temporarily intelligently changed by the system based on some details of a trip—for example, temporarily including the KIDS selector if the vehicle microphone picks up a child's voice.

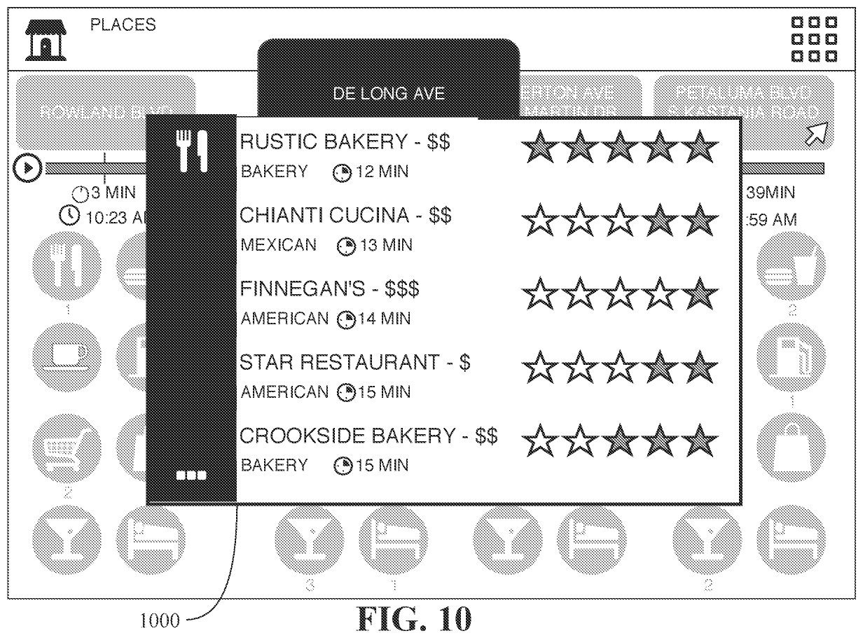

Any interface, when brought up by a selector, may simply be a display which has no interactive elements, or which may have only an interactive element to close the interface, though any of the disclosed interfaces may also have interactive elements, such as additional selectors to be selected by a user to accomplish other tasks or bring up other information, or otherwise for navigation to other interfaces/windows. In any instance in which an interface is brought up by selecting a selector the interface may replace the preexisting interface on the display, or it may be shown as an inset interface with the background interface still shown (or shown in a grayed-out fashion, as illustrated in FIG. 10 as a representative example), and in such instances the user may be able to return to the underlying screen/interface by touching the screen anywhere outside of the topmost interface/screen.

As indicated above, FIG. 9 shows a representative example of an interface 900 which is displayed when a user selects the Places selector from interface 800. In general, the longer a trip, the more stops the driver is likely to make, such as for food, gas, snacks, bathroom breaks, and so on. The Places interface shown in FIG. 9 depicts, in the representative example, the next four exits along the driver's route. Rowland Boulevard is 6 minutes away, with an expected arrival time of 8:59 AM. De Long Avenue is 11 minutes away, with an expected arrival time of 9:04 AM, and so on. In implementations exits that have already been passed are not displayed as a driver may not want to backtrack, though in implementations a user could change this setting by using a settings interface which may be brought up using a selector (not shown) on a home screen such as interface 700 or 800. Places that are more than 10 minutes off-route also may not be displayed, though again this may in implementations also be changed by editing a user's preferences in a settings interface. Under each exit sign are icons that indicate the types and numbers of services are available; services that are not available are grayed out in the representative example. For example, travelers can find sit-down restaurants (fork and knife icon), fast food restaurants, fuel/charge stations, and grocery stores if they exit at Rowland Blvd, but not coffee, shopping, bars, or overnight accommodations (e.g., hotel). De Long Avenue, on the other hand, offers more options, including coffee, shopping, overnight accommodations and bars. Showing a list of the different services available at each possible waypoint allows a driver to choose which stop will accomplish multiple tasks in the least amount of time possible. Suppose the driver selects the dining (sit-down restaurant) icon under the De Long Avenue exit. This brings up a list of restaurants that are open or will be open by the anticipated arrival time where the driver can eat, as shown in FIG. 10 with interface 1000.

In implementations fewer or more stops/exits could be shown on interface 900. The top right corner of interface 900 shows a grid icon which may be selected to bring the user back to the top menu interface 800. It is also seen in FIG. 9 that interface 900 shows the number of each type of item, for instance at the Atherton Ave./San Martin Dr. exit the user would find one fast food restaurant, one coffee shop, and two fuel/charge stations. In implementations the icons of FIG. 9 may be selected to bring up more information about a selected icon—such as a list of fast food restaurants or a list of gas stations with prices, and so forth.

In FIG. 10 the user has selected the sit-down restaurant icon under the De Long Ave. exit (such as by touching or otherwise selecting the icon) and interface 1000 has, in response, appeared on top of interface 900 (which is then grayed out). The dining options displayed in interface 1000 may include information such as the name, average cost of a meal, type of cuisine, number of minutes away from current location, average rating, and so forth. The driver may then select a particular restaurant and complete other tasks (e.g., get a newspaper and fill gas). By selecting a particular restaurant, such as with a touch selection or other selection, from interface 1000 the system may update the user's trip to include a stop at the restaurant and to navigate the user there. A selector (three dots) at the bottom left of interface 1000) could be selected to adjust food settings, such as desired cuisine of a user, desired rating level, desired price level (on this and/or other trips) to be shown on interface 1000. In implementations a user could tap or otherwise select the rating of a restaurant to bring up reviews of the restaurant in the display, which in implementations may be read to the user.

Although FIG. 10 gives the specific example of the user selecting sit-down restaurants to see in more detail, in implementations a window such as that of FIG. 10 could be shown in response to the user selecting any other icon, for example an interface showing similar information related to coffee shops off of Atherton Ave./San Martin Dr. when a user selects the coffee icon under that stop, or an interface showing similar information related to grocery stores off of Rowland Blvd. when the user selects the shopping cart icon under that stop, and so forth.

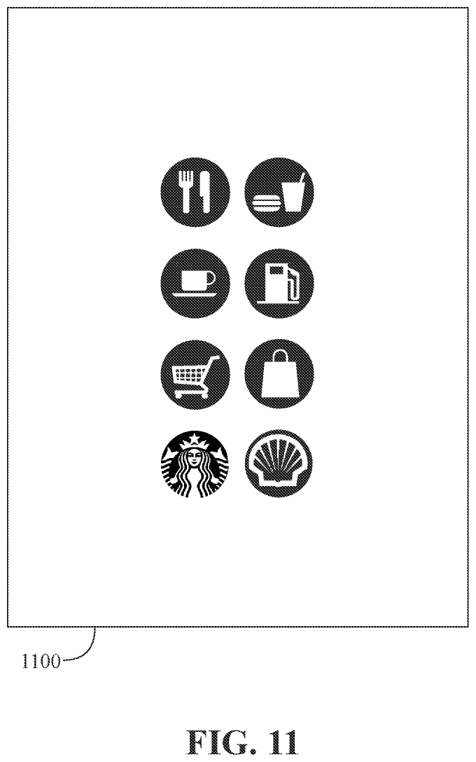

In implementations the icons of FIG. 9 are customizable and editable. For example, a driver can remove services they don't want or would never use and add services they do want or use frequently. As shown in FIG. 11, the system may include an interface 1100 (such as accessible from a settings interface or interface 900 using a not-shown selector) wherein a user may select desired services and icons. In FIG. 11 the user has added a STARBUCKS icon and a SHELL icon to display his often-used coffee shop and gas station brand, respectively. In such an implementation the user could, if desired, then remove the coffee shop and gas station icons, so that the system only displays to the user which stops have STARBUCKS coffee shops and SHELL gas stations. Further customization may be done—for example a user could leave the gas icon unchanged but edit the settings so that only SHELL and ARCO gas stations are shown, edit the shopping icon to a MACY'S icon and adjust the settings so that only MACY'S and IKEA stores are shown with regards to shopping locations, remove the fast food option entirely, and so forth. In implementations the system includes a store of icons of specific services/places for user customization. On interface 1100 a user could see the settings of a particular service/item by tapping the respective icon, edit the settings or icon image by long-pressing or double-tapping the respective icon, and/or other verbal commands/options may be available using other actions.

Another example of an interface that could be implemented would be a FILL UP interface (such as when the user selects the FILL UP icon from interface 800 of FIG. 8). The FILL UP interface could, in implementations, include a ranked listing of tables without any geography. For example, the vehicle computer and/or the Trip Brain will know how much longer the vehicle can drive before needing to fill up. With that in mind, the FILL UP interface may show a first table which lists the best fill-up stations in terms of detour time (e.g., they could be ranked 1-4 with 1 being the station that takes the least amount of time away from the trip). A second table could rank fill-up stations according to price. A third table could rank fill-up stations according to a combination of detour time and price, and so forth. In the case when FILL UP refers to a charge station, a table could show the best charge stations in terms of proximity to other walkable activities (e.g., nearby coffee shops and other businesses) and density of such activities. Other tables or information could be shown on the FILL UP interface, and a user may select the preferred station from any of the tables, and that location will be added to the directions.

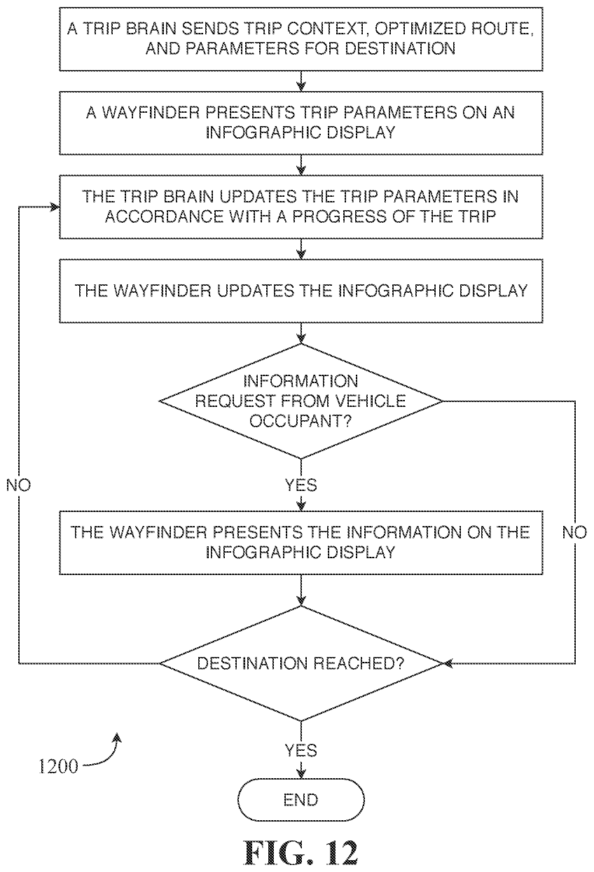

FIG. 12 shows a flow diagram (flowchart) 1200 depicting the general operation of Wayfinder as discussed above. Referring to the flow diagram, in implementations the Trip Brain determines the six qualities of trip context and sends an optimized route for the trip and trip parameters such as traffic and waypoints as discussed above. Information about the trip may be presented to a traveler in the form of an infographic as shown in FIGS. 6 and/or 7. As the trip progresses and more information is collected and analyzed by the Trip Brain, Wayfinder presents updated trip parameters in accordance with a progress of the trip. For example, a traffic jam might change the estimated time of arrival or may necessitate a rerouting of the trip. The traveler is notified about the updated trip parameters via the infographic display (and, in some implementations or according to user settings, audibly by the AI Sidekick).

At some point in the trip, Wayfinder may receive a request for information associated with the trip from the traveler. For example, the driver may select the FILL UP option to search for a gas or charging station (this interaction, like many others, may be done using one or more of the user interfaces and/or audibly by driver interaction with the AI Sidekick). Wayfinder then presents the requested information to the driver in accordance with the current trip parameters. Wayfinder periodically checks to see if the destination is reached. This is done on an ongoing basis until the destination is reached. If the destination is not reached, Wayfinder continues to present updated trip parameters in accordance with a progress of the trip. When the destination is reached, the process ends. This is only one representative example of a flowchart of the Wayfinder service, and other implementations may include fewer or more steps, or steps in different order.

Music Compilation Service (Soundtrack)

Referring back to FIG. 7, in implementations a user may select the Music Compilation icon at the bottom center of the screen to initiate the Music Compilation service. Selecting this selector may start playing music directly, but in implementations it may also bring up one or more user interfaces which show details of the Music Compilation—such as currently playing song, next song, selectors to pause/skip/fast-forward/rewind, and so forth. In implementations when a user selects the Music Compilation icon from interface 700 the details of the Music Compilation may simply appear or be shown within interface 700 itself, such as below the trip information at the top of interface 700, though in other implementations there may be a separate Music Compilation interface that is brought up when the user selects the Music Compilation icon on interface 700 and then the user may revert back to interface 700 by selecting a selector on the Music Compilation interface (or the system may be set to automatically revert to interface 700 after no user interaction has been received by a predetermined amount of time, such as a few minutes).

In implementations the system implements the Music Compilation service in a way that it is noticeably different from conventional music streaming services, so that the Music Compilation is a DJ-like compilation. This may return music listening in the vehicle to something more like an art form. In implementations the Music Compilation service creates a soundtrack for the trip (or in other words selects songs and portions of songs for a soundtrack) based on the details of the drive. The Music Complication service (which may be called Soundtrack) may be implemented using the Trip Brain, though some portions of the implementation may be done using one or more servers and/or databases of the system and/or in conjunction with third party APIs (such as accessing music available through the user's license/profile from one or more third-party music libraries) and such. In implementations the Music Compilation service is implemented by the Trip Brain adaptively mixing music tracks and partial music tracks in a way that adjusts to the nature and details of the trip, instead of playing music tracks in a linear, sequential yet random fashion as with conventional music streaming services. The Trip Brain in implementations implements the Music Compilation service by instead mixing tracks and partial tracks that are determined by the Trip Brain to be appropriate for the current trip, the current stage of the trip, and so forth.

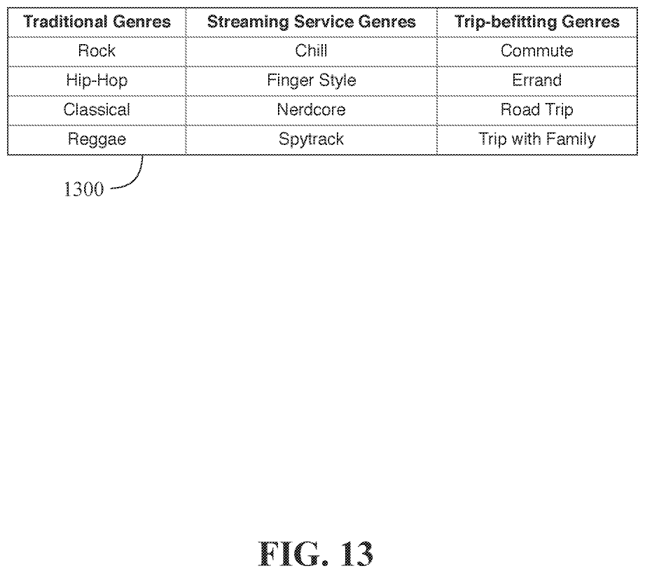

In implementations a Music Compilation method implemented by the system includes a step of classifying music tracks and/or partial tracks not according to music style (or not only according to music style), but according to the context of a trip. A representative example is given in table 1300 of FIG. 13, wherein trip contexts of commute, errand, road trip, and trip with family are given. In other implementations there may be fewer or more trip contexts, such as: commute to work, commute from work, doing taxiing work (such as through LYFT or UBER), late night return home, and so forth. Table 1300 compares the trip-befitting genres with lists of categories that might be used in conventional streaming services, such as traditional genres of rock, hip-hop, classical and reggae, or streaming service genres of chill, finger-style, nerdcore and spytrack. The Music Compilation method may use track and portions of tracks from these and any other genres, but weaves them into a compilation that is fitting for a given trip.

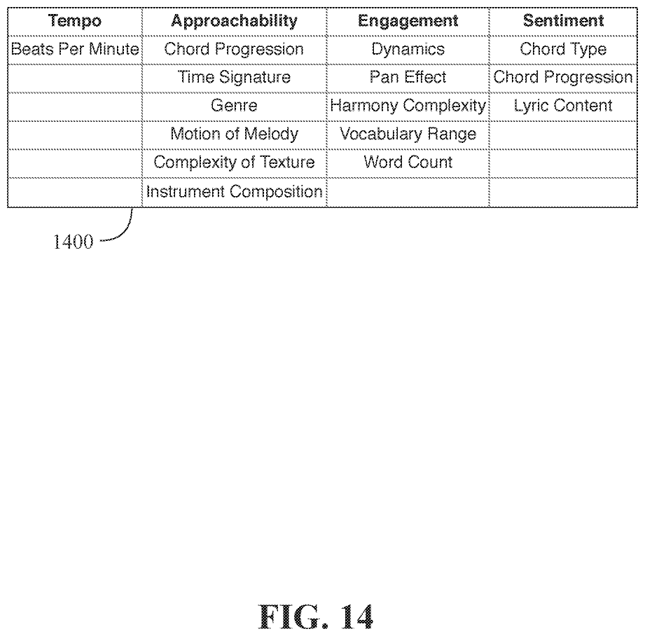

In implementations the Music Compilation method includes analyzing each song by multiple criteria. One representative example of this is given by table 1400 of FIG. 14, which representatively illustrates that a Music Compilation method may analyze each song by the four criteria of tempo, approachability, engagement and sentiment. Tempo in this implementation refers to beats per minute. Approachability in this implementation is related to how accessible versus how challenging the song is. Engagement refers to whether the song is a “lean forward” (e.g., requiring attention) or “lean backward” (e.g., being in the background) song, and sentiment refers to the mood of a song. In implementations each criteria may be further broken down (or may include) sub-categories, so that in the representative example: tempo, as indicated, includes beats per minute; approachability includes chord progression, time signature, genre, motion of melody, complexity of texture, and instrument composition; engagement includes dynamics, pan effect, harmony complexity, vocabulary range, and word count; and sentiment includes chord type, chord progression, and lyric content.

Accordingly, in implementations, instead of dividing a music catalog into traditional genres or streaming service genres, the Music Compilation service organizes the music catalog according to what type of drive (like commute to work or errand) and social dynamic a song is appropriate for. As an example, a traveler will listen to different music if alone in the car versus driving with a 9-year old daughter or versus traveling with a business contact who may be classified as a weak social connection. In this sense, the Music Compilation service (in other words, the Music Compilation method) is done in a context-aware and trip-befitting manner.

This type of Music Compilation in implementations results in playlists that are not necessarily linear, or in other words the songs in the playlist are not necessarily similar to one another. Additionally, the method may exclude random selection of songs (or random selection within a given category) but is much more curated to fit the conditions of the trip and/or the mood of the occupants. In this way the method includes effectively creating a DJ set, utilizing the nuanced skills and rules that make a soundtrack befitting for a particular journey. This includes, in implementations, selecting an optimal song order for a drive including when to bring the vibe up, when to subtly let the mood drop, when to bring the music to the forefront, when to switch it to the background, when to calm, when to energize, and so forth. The Trip Brain and/or other elements of the system may determine, based on the trip details, how long the set needs to be, appropriate moods, appropriate times to switch the mood, and so forth.

The Music Compilation methods may also include, at times, using only samples of songs instead of only full tracks. In short, the Music Compilation methods may utilize professional DJ rules and DJ mix techniques to ensure each soundtrack or set enhances a traveler's mood.

Referring back to FIG. 14, more detail might be given about representative analysis criteria, as follows, which might be used by the methods and by the system to curate a playlist for any given trip.

Tempo

Beats per minute is a metric used to define the speed of a given track.

Approachability

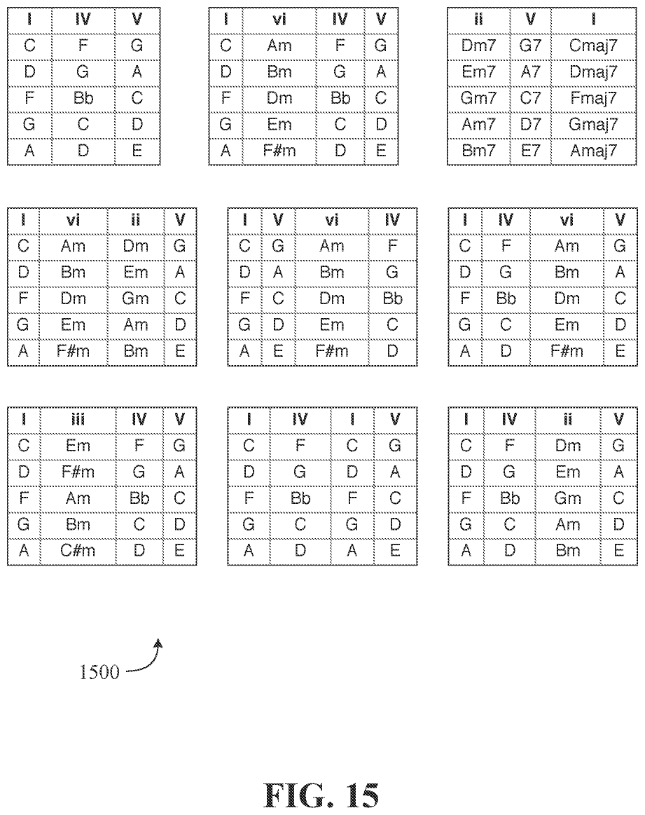

Chord progression—Common chord progressions are more familiar to the ear, and therefore more accessible to a wider audience. They are popular in genres like rock and pop. Genres such as classical or jazz tend to have more complex, atypical chord progressions and are more challenging. Tables 1500 of FIG. 15 show a number of common chord progressions. The system and method could use any of these chord progressions, or other chord progressions, to categorize any given track along a spectrum of typical to atypical chord progression.

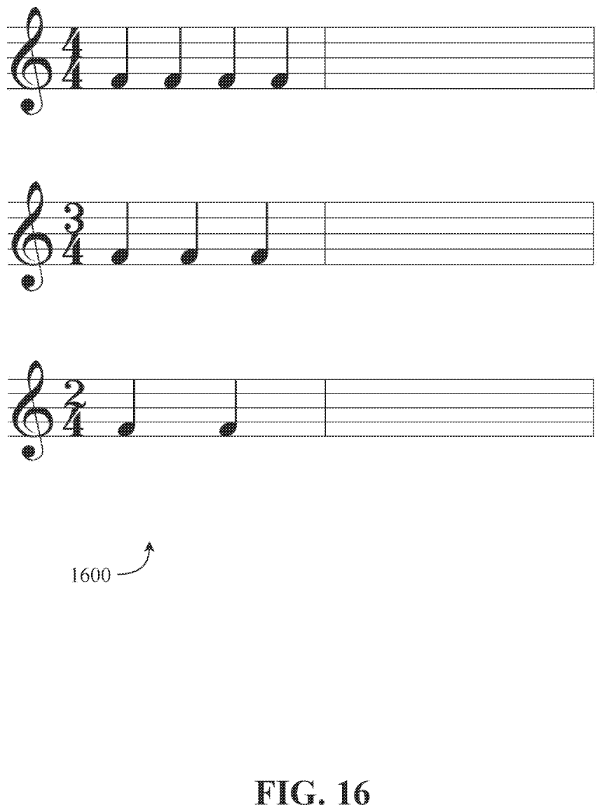

Time Signature—Time signature defines the beats per measure, as representatively illustrated in diagram 1600 of FIG. 16. The most common and familiar time signature is 4/4, which makes it the most accessible. 3/4 is significantly less common (and therefore marginally more challenging), but still relatively familiar, as heard in songs such as Bob Dylan's “The Times They Are A-Changin'.” Uncommon time signatures such as 5/4 (e.g., Dave Brubeck's “Take Five”) are more challenging as they are more complex and engaging than traditional time signatures. Also worth noting is that songs can have varying time signatures. As a non-limiting example, The Beatles' “Heavy” is 4/4 in the verses and 3/4 in the chorus. FIG. 16 only representatively illustrates the 4/4, 3/4, and 2/4 time signatures, but the system and method may determine (and asses approachability) according to any time signature, including by non-limiting examples: simple (e.g., 3/4 and 4/4); compound (e.g., 9/8 and 12/8); complex (e.g., 5/4 or 7/8), mixed (e.g., 5/8 & 3/8 or 6/8 & 3/4), additive (e.g., 3+2/8+3), fractional (e.g., 2½/4), irrational (e.g., 3/10 or 5/24), and so forth.

Genre—More popular and common genres of music such as rock, R&B, hip-hop, pop, and country are more accessible. Less popular genres like electronic dance music, jazz, and classical can be less familiar, and more challenging. The systems and methods may accordingly use the genre to categorize a track as more or less approachable, accordingly.

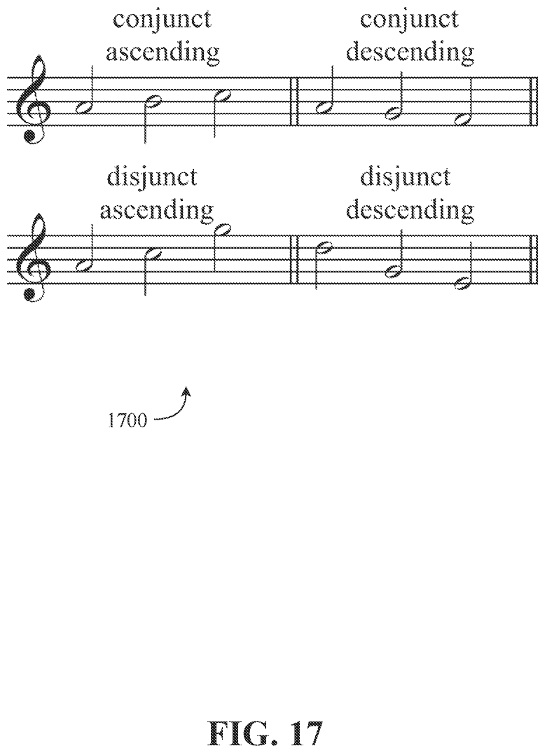

Motion of Melody—Motion of Melody is a metric that defines the variances in melody's pitch over multiple notes. This is representatively illustrated by diagram 1700 of FIG. 17. Conjunct melody motions have less variance, are more predictable, and are therefore more accessible (i.e., more approachable), while disjunct melody motions have a higher variance, are less predictable, and are more challenging (and so less approachable).

Complexity of Texture—Texture is used to describe the range of which the tempo, melodies, and harmonics combine into a composition. For example, a composition with many different instruments playing different melodies—from the high-pitched flute to the low-pitched bass—will have a more complex texture. Generally, a higher texture complexity is more challenging (i.e., less approachable), while a lower texture complexity is more accessible—easier to digest for the listener (i.e., more approachable).

Instrument Composition—Songs that have unusual instrument compositions may be categorized as more challenging and less approachable. Songs that have less complex, more familiar instrument compositions may be categorized as less challenging and more approachable. An example of an accessible or approachable instrument composition would be the standard vocal, guitar, drums, and bass seen in many genres of popular music.

Engagement

Dynamics—Songs with varying volume and intensity throughout may be categorized as more lean-forward, while songs without much variance in their volume and intensity may be categorized as more lean-backwards.

Pan Effect—An example of a pan effect is when the vocals of a track are played in the left speaker while the instruments are played in the right speaker. Pan effects can give music a uniquely complex and engaging feel, such as The BEATLES' “Because” (lean-forward). Songs with more or unique pan effects may be categorized as more lean-forward, while songs with standard or minimal pan effects are more familiar and may be categorized as more lean-backwards.

Harmony Complexity—Common vocal or instrumental harmonic intervals heard in popular music—such as the root, third, and fifth that make up a major chord—are more familiar and may be categorized as more lean-backwards. Uncommon harmonic intervals—such as root, third, fifth and seventh that make up a dominant 7 chord—are more complex, uncommon, and engaging and may be categorized as more lean-forward. The BEATLES' “Because” is an example of a song that achieves high engagement with complex, uncommon harmonies.

Vocabulary Range—Vocabulary range is generally a decent metric for the intellectual complexity of a song. A song that includes atypical, “difficult” words in its lyrics is more likely to be described as lean-forward—more intellectually engaging. A song with common words is more likely to be described as lean-backwards—less intellectually engaging.

Word Count—Word count is another signal for the complexity of the song. A higher word count can be more engaging (lean-forward), while a lower word count can be less engaging (lean-backwards).

Sentiment

Chord Type—Generally, minor chords are melancholy or associated with negative feelings (low sentiment) while major chords are more optimistic or associated with positive feelings (high sentiment).

Chord Progression—If a song goes from a major chord to a minor chord it may be an indication that the sentiment is switching from high to low. If the chord progression goes from major to minor and back to major it may be an indication that the song is uplifting and of higher sentiment. Other chord progressions may be used by the system/method to help classify the sentiment of a song.

Lyric Content—A song that has many words associated with negativity (such as “sad,” “tear(s),” “broken,” etc.) will likely be of low sentiment. If a song has words associated with positivity (such as “love,” “happy,” etc.) it will more likely be of high sentiment.

Accordingly, the systems and methods may analyze the tempo, approachability, engagement, and sentiment of each track based on an analysis of the subcategories, described above, for each track. In implementations fewer or more categories (and/or fewer or more subcategories) may be used in making such an analysis. This analysis could be done at the Trip Brain level or it could be done higher up the system by the servers and databases—for example one or more of the servers could be tasked with “listening” to songs in an ongoing manner and adding scores or metrics in a database for each track, so that when a user is on a drive the system already has a large store of categorized tracks to select from. Alternatively or additionally, the Trip Brain may be able to perform such an analysis in-situ so that new tracks not categorized may be “listened” to by the Trip Brain (or by servers communicating with the Trip Brain) during a given trip and a determination made as whether to add it to, and where to add it to, an existing trip playlist so that it is then played audibly (in full or in part) for the user. Various scoring mechanisms could be used in categorizations. For example, with regards to engagement each sub-category could be given equal weight. This could be done by assigning a score of 0-20 to each sub-category, so that a song with maximum dynamics, pan effect, harmony complexity, vocabulary range and word count would be given a score of 20+20+20+20+20=100 for engagement (i.e., fully lean-forward). In other implementations some sub-categories could be given greater weight than other sub-categories, and in general various scoring mechanisms could be used to determine an overall level for each main category.

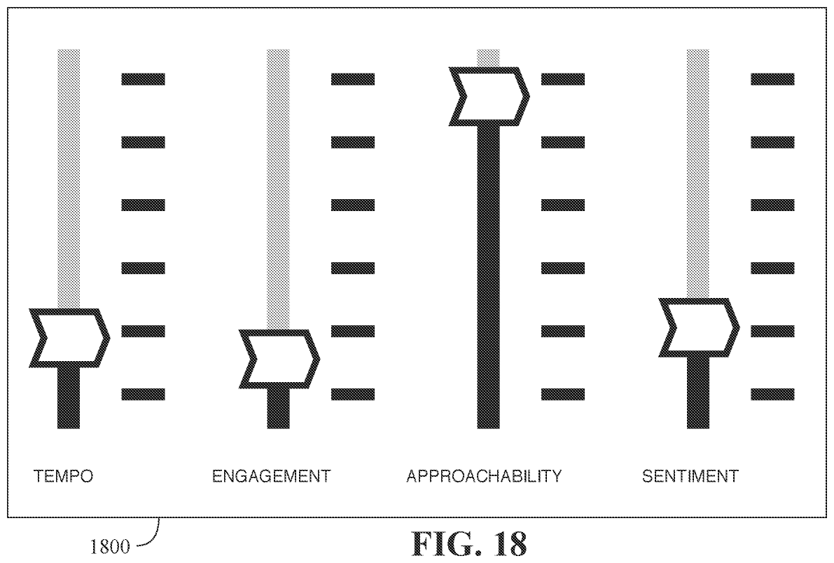

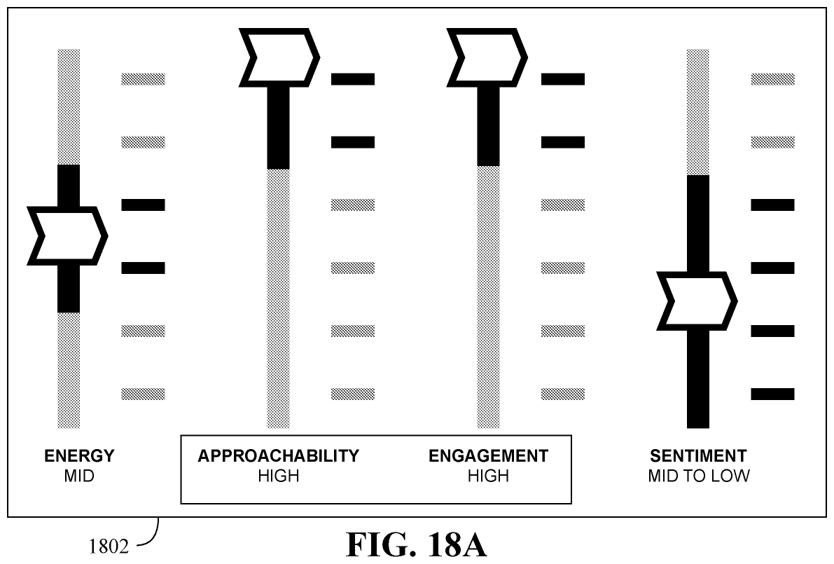

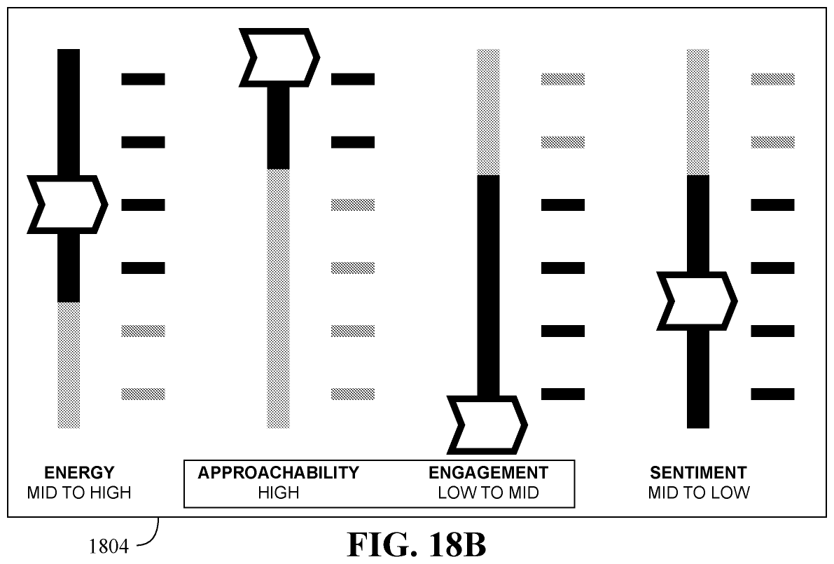

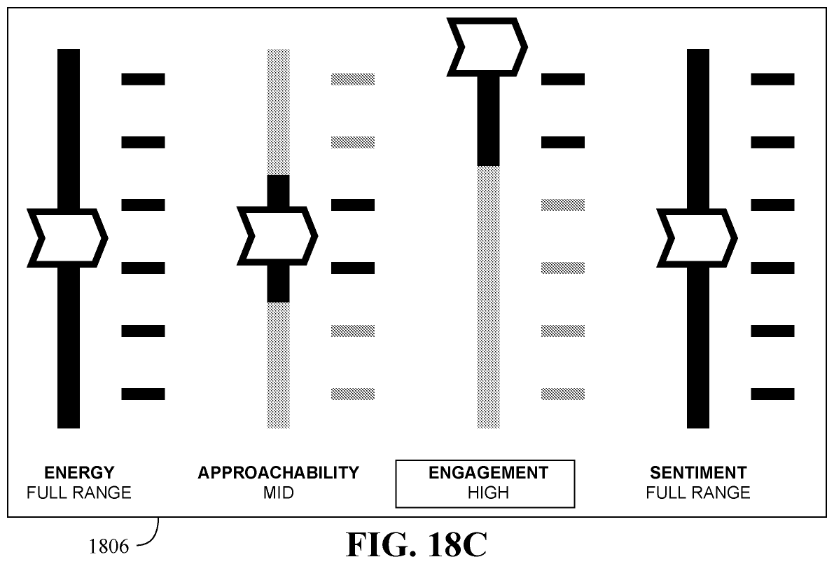

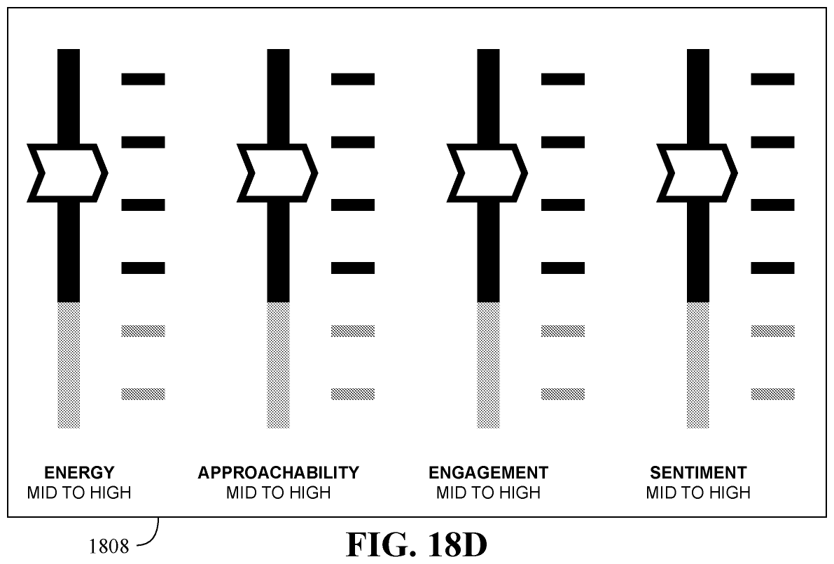

As a further example, suppose a driver is taking a highway trip. Here, it may be desirable to have mid-tempo songs to discourage speeding, and to keep engagement low so that the traveler's mind can wander. Let us also suppose that based on the composition of passengers in the cabin it may be desirable to have high approachability, and that (also based on the composition of passengers) it may be desirable to have a low-key or neutral sentiment to the music. The system may, based on these determinations, select an internal setting for the music. This is representatively illustrated by diagram 1800 of FIG. 18, which representatively illustrates a level for each setting so that tempo, engagement, and sentiment are set to low levels while approachability is set to a very high level. FIG. 18 only representatively illustrates, however, what is happening internal to the system—the user may never actually see such a diagram indicating the settings chosen by the system.

It will be pointed out here that various methods may be used to determine how many people, and which specific people, are in the cabin in order to help determine appropriate levels for each category. BLUETOOTH connections from the system (or Trip Brain of the system) to users' mobile phones may, as an example, indicate to the system who is present in the vehicle. The system may determine based on sound input gathered from a microphone of in-car conversations whether any given passenger is a weak, medium or strong social connection. Some such information could also be gathered by using information from social media or other accounts—for example are these two passengers FACEBOOK friends, or are they not FACEBOOK friends, but are they associated with the same company on LINKEDIN, did this trip begin by leaving a workplace in the middle of the day (i.e., more likely a trip with coworkers and/or boss and/or subordinates), did the trip begin by leaving home in the evening (i.e., more likely a trip alone or with family), and so forth. Granted, such information gathering may be considered by some to be invasive of privacy, and the systems and methods may be tailored according to the desires of a user and/or the admin according to acceptable social norms and individual comfort level to provide useful functions without an unacceptable level of privacy invasion. The system may for example have functions which may be turned on or off in a settings interface at the desire of the user.

Returning to our example of the highway trip, if there is a traffic jam the system may, upon gathering info from the vehicle navigation suite and/or communicatively connected third party services (such as GOOGLE maps) determine that there is a traffic jam. The system may then dynamically adjust the levels so that the tempo goes up, engagement switches from low to high, and so forth to switch from more background-like music to lean-forward music in order to distract the traveler from the frustrating road conditions, and the sentiment may also appropriately switch to positive and optimistic.

In implementations the system may identify the key of each song to determine whether any two given songs would fit well next to each other in a playlist, i.e., whether they are harmonically compatible. The system could for example use a circle-of-fifths, representatively illustrated by diagram 1900 of FIG. 19, and a stored key for each song to ensure that a playlist moves around the circle and between the inner and outer wheels with every mix, progressing the soundtrack as desired and as would be done by a professional DJ.

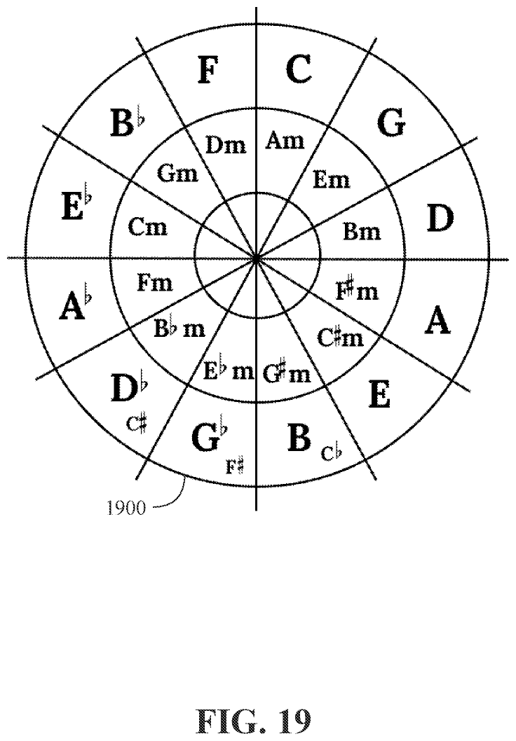

The system may also implement a cue-in feature to determine where to mix two tracks, identifying the natural breaks in each song to smoothly overlay them. Diagram 2000 of FIG. 20 representatively illustrates this, where sound profiles of a first track (top) and second track (bottom) are analyzed to determine the most likely places of each track (shown in gray) for one track to mix and switch to the other track. In such a mixing the first track may not completely finish before the second track mixes in, and similarly the second track may not be mixed in at the very beginning of the second track, but rather the tracks may be mixed in at locations of each song that would provide for the best transition between songs. The system may also use a transition technique such as fading out the first track and fading in the second track for a smoother transition.

The Music Compilation service can operate in conjunction with music libraries and music streaming services to allow travelers to shortcut the art of manually creating their own mixes, while retaining the nuanced skills and rules to make a befitting soundtrack for each particular journey. One or more algorithms associated with the Music Compilation service may be configured to curate the right mix for each drive and know when to adjust the settings either ahead of time or in-situ as situations change.

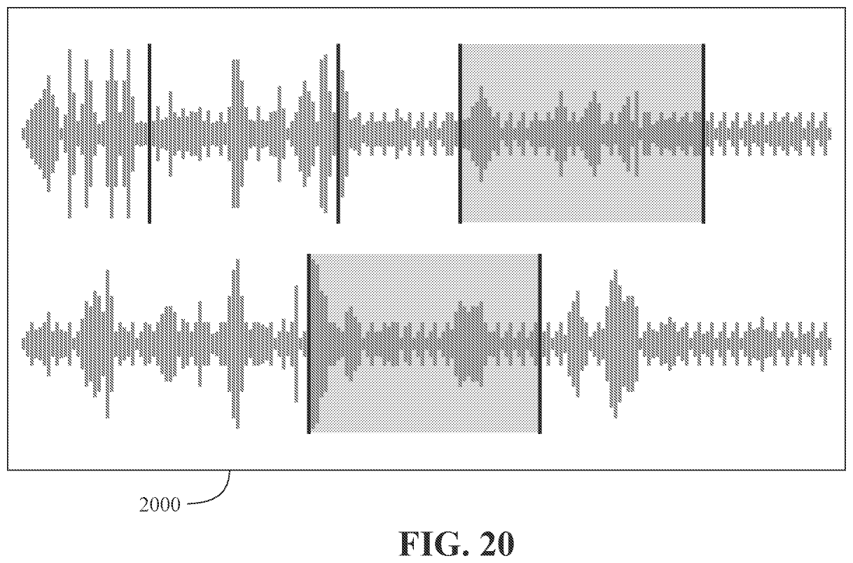

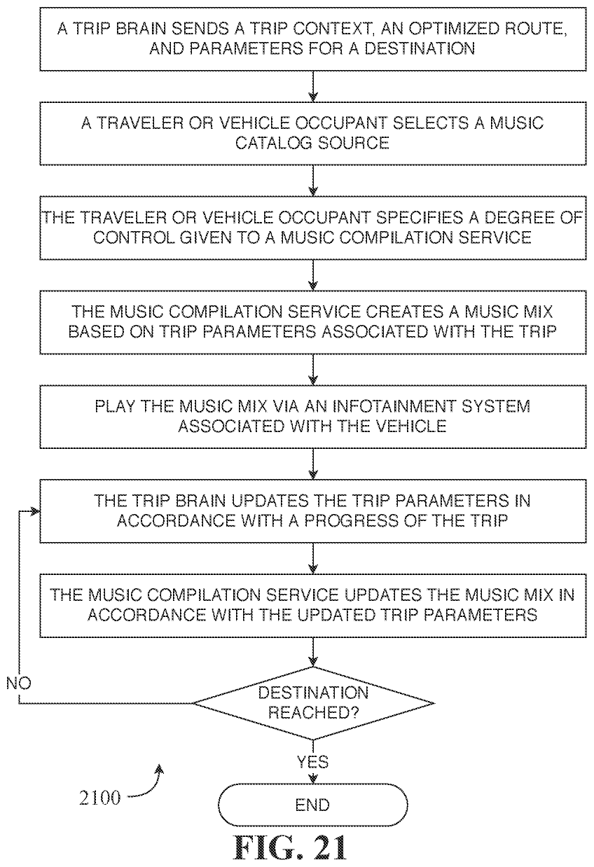

Flow diagram (flowchart) 2100 of FIG. 21 representatively illustrates a method of operation of the Music Compilation service, as carried out by the system. In implementations the Trip Brain determines the six qualities of trip context and sends an optimized route for the trip and trip parameters such as traffic and waypoints as discussed above. Information about the trip may be presented to a driver of a vehicle in the form of an infographic as shown in FIGS. 6 and/or 7. Next, a traveler or vehicle occupant may select a music catalog source. This could for example be done by selecting from a prepopulated list of cloud-based catalog sources such as ITUNES, SPOTIFY, and/or the like which a user may input profile and login information for in order for the system to use music from those libraries to create the playlist, or the user may link some other account or library storage location to the system for this purpose. The system could also have its own default library of tracks which may be used if a user does not select a specific library or set of libraries.

The driver or a passenger specifies the amount of control given and music to be used by the Music Compilation service. This may be done using one or more inputs or selections on one or more user interfaces and/or through audio commands to the AI Sidekick. The user could for instance instruct the system to include certain songs in the playlist or to create a playlist entirely from scratch, could ask for a playlist within certain parameters such as an engaging or exciting playlist or a more chill playlist, could review the playlist before it begins and make edits to it at that point or leave it unaltered, could pause the playlist at any point along the trip, could request a song to be skipped or never played again, could ask for a song to be repeated, and so forth. Some of these settings may be edited in a settings menu to be the default settings of the Music Compilation service.

Referring still to FIG. 21, the Trip Brain creates a mix from a plurality of music tracks associated with the driver-selected music catalog(s) based on the trip parameters as determined by the Trip Brain. The Music Compilation service may play the music mix via an infotainment system associated with the vehicle (this may simply be the speakers of the vehicle playing the audio with associated track information shown on a user interface on the display of the vehicle, which user interface may also include selectors for skipping, rewinding, fast forwarding, pausing, etc.). As the trip progresses the Trip Brain updates the trip parameters in accordance with a progression of the trip, and in response the Music Compilation service may update the music mix in accordance with the updated trip parameters. For example, during a traffic jam the Music Compilation service may change its internal settings (e.g., sentiment, engagement, etc.) and revise its track selections accordingly. On an ongoing basis, the Trip Brain checks to see if the destination is reached. If the destination is not reached, the Trip Brain returns to updating the trip parameters in accordance with a progress of a trip and the Music Compilation service adjusts accordingly. If the destination is reached, the process ends. In implementations, the user may be able to save and name the soundtrack that was just played locally to the vehicle or to a remote location (e.g., database storing user information). In implementation, the user may be able to re-play a saved soundtrack through a selection on one or more of the user interfaces in the vehicle or by instructing the AI Chatbot through an audio command. In implementation, the system may add metadata to the saved soundtrack such as date played, time played (e.g., 11:04 AM until 12:56 PM), start and/or end points for the trip, and so on. In implementations, the user may be able to recall the saved soundtrack.

In implementations, the Music Compilation service may provide multiple partial soundtracks for a particular drive. Each partial soundtrack may be based on trip conditions and context, in addition to the particular preferences and characteristics of one or more travelers in the vehicle. Hence, the trip soundtrack may be controlled, in duration or partially, by the driver, as well as any of the passengers in the car.

The Music Compilation service may, in other implementations, include more or fewer steps, and in other orders than the order presented in FIG. 21.

The Music Compilation service/methods may work seamlessly with other system elements to accomplish a variety of purposes. For example, the Music Compilation service may work with the Wayfinding methods to determine how long a playlist should be, when to switch the mood (e.g., during traffic jams), and so forth. The Music Compilation service/methods could also work pauses (or volume decreases) into the playlist, such as at likely stops for gas, restroom breaks, food, and so forth when passengers may be more engaged in discussion. The system may also proactively reduce volume when conversations spark up on a given trip as determined by measuring the sound coming into a microphone of the system (which may simply be a vehicle microphone). As another example, the system may detect a baby crying in the vehicle and, in response, switch the music to soothing baby music, or music that has proven in the past to calm the baby.

In implementations the Music Compilation service could be implemented in any type of transportation setting, automobile or otherwise, but the Music Compilation service is not limited to vehicle settings. As many of the Music Compilation methods as could feasibly be implemented in a non-vehicle setting may be, such as through a streaming service implemented through a website (such as using the web server of FIG. 1), through a mobile device application (such as using the application server of FIG. 1), and so forth. In this way, the Music Compilation service could be implemented apart from and independent from any vehicle setting, but could be simply utilized as a music streaming service that incorporates the methods and characteristics described above.

AI Sidekick/Interactive Chatbot

In implementations the system 100 may be used to implement an artificial intelligence (AI) Sidekick which interacts with travelers through the display and/or through audio of the vehicle. In implementations the Sidekick is an Interactive Chatbot which can learn and adapt to the driver and other occupants of the vehicle. In implementations the Interactive Chatbot service tailors its support of the car inhabitants to the unique environment of the car. It may, for example, focus at times on enhancing the wellbeing of the travelers and the sanctuary-like nature of the car. The Interactive Chatbot in implementations and/or in certain settings may instruct or teach the travelers, and in such instances may be a pedagogical chatbot. In implementations the AI Sidekick is not merely a chatbot assistant (i.e., only shortcutting tasks for the user) but is more of a companion—more emotionally supportive as opposed to only tactically or functionally supportive.

The AI Sidekick may at times support or promote mind-wandering of the travelers, creative thinking, problem solving, brainstorming, inspiration, release of emotion, and rejuvenation. It may help to ensure that time in the car is an opportunity to release emotions not allowed in other contexts. It may ensure that the vehicle is a space where travelers can process thoughts and feel more “themselves” when they step out of the car than they did when they got in. The chatbot may help a traveler transition from one persona or role to another (for instance on the commute home transitioning from boss to wife and mom). The chatbot may give travelers the opportunity to reflect on their day and vent, if appropriate.

To implement the chatbot's role, the Trip Brain may use various data sources including vehicle sensors, the traveler's calendar, trip parameters, and so on to determine a traveler's mood, state of mind or type of transition (if appropriate). For example, vehicle sensors can detect if the driver is gripping the steering wheel harder than usual. Other sensors in the seat can tell the Trip Brain that the traveler is fidgeting more than usual in his seat. Accelerometer readings can inform the Trip Brain that the traveler's driving style is different than usual (e.g., faster than usual, slower reaction time than usual, etc.).

In implementations the traveler may adjust, through one or more user interfaces or through audio commands, the level of intervention and support provided by the Interactive Chatbot. If the Trip Brain determines that the traveler is likely to be in a bad mood and if permitted by the traveler's control setting, the Interactive Chatbot may invite the traveler to share his experience to help him open up about his problems. The chatbot may, in implementations, not be simply reactive (i.e., only responding to user initiation and self-reporting). Rather, the Interactive Chatbot may be set to either be more proactive and assess the validity of self-reported information or initiate appropriate questions based on sensory input, or may be set to simply be reactive and let the user initiate interaction.

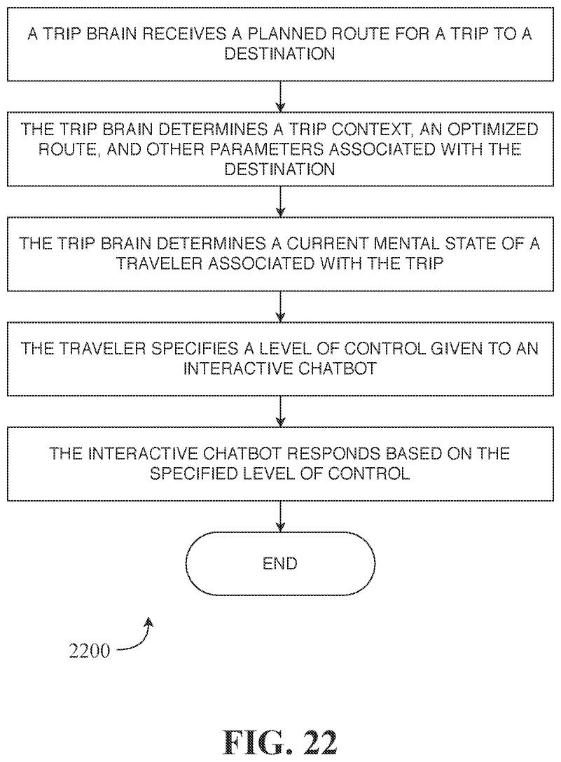

Flow diagram (flowchart) 2200 of FIG. 22 illustrates a representative example of operation of the Interactive Chatbot. Initially, the Trip Brain receives a planned route for a trip to a destination. The Trip Brain analyzes the planned route to determine trip parameters such as traffic and waypoints as discussed above. Information about the trip may be presented to a driver of a vehicle in the form of an infographic as shown in FIGS. 6 and/or 7. The Trip Brain determines the traveler's current mental state, which may be accomplished by analyzing the trip parameters, vehicle sensors, and the environment in the vehicle (e.g., use of infotainment). During the trip, the Trip Brain constantly monitors the aforementioned data sources and updates mental state assessment as appropriate. Depending on the level of control that the traveler has specified for a particular trip, the Trip Brain may adjust the environmental conditions on the vehicle (e.g., temperature, volume, song mix, etc.) or offer an interactive conversational environment using the Interactive Chatbot for as long as the traveler would like to engage.

The Interactive Chatbot service may, in other implementations, include more or fewer steps, and in other orders than the order presented in FIG. 22.

Speaking now broadly about various system benefits, system 100 and related methods may provide alternative approaches to viewing the vehicle environment, i.e., as an experience for the traveler as a passenger instead of only as a driver. The systems and methods disclosed herein allow the driving experience to be about lifestyle, leisure activity, learning, well-being, productivity, and trip-related pleasure. Systems and methods described herein allow the vehicle to serve as a task-negative space (analogous to the shower) that lets travelers' minds wander, helps them emotionally reset, and serves as a sanctuary and a place of refuge. This allows travelers to derive profound personal benefit from a journey. Time in the vehicle is transformed into an opportunity to release emotions that might not be allowed anywhere else. It becomes a space where travelers can process thoughts and feel more “themselves” after stepping out of the car.

Systems and methods described herein promote creative thinking and inspiration by providing a place and atmosphere to reboot the traveler's brain. These systems and methods help to provide a cognitive state of “automaticity” where the mind is free to wander. This allows the subconscious mind of the traveler to work on complex problems, taking advantage of the meditative nature of drives.

Systems and methods described herein provide a chatbot that is much more than a virtual assistant for productivity, but is rather a virtual Sidekick in the car that is proactive, supportive, resourceful, and charismatic.

Various aspects and functionalities of systems and methods described herein operate together as a single system and not as a set of disjointed applications. This allows applications, alerts, information, vehicle sensors and data, entertainment, and so forth to be woven together seamlessly into a delightful, unified travel experience. Wayfinding using the systems and methods herein includes more than transactional navigation but also adventure, exploration and possibility. Music listening using the systems and methods herein is more artistic, deep, meaningful, personalized, and intimate than the common linear streaming experiences of similar-sounding songs.

In implementations systems and methods disclosed herein may allow access to all system functionalities with an in-vehicle humanized voice-enabled agent (aforementioned Interactive Chatbot or AI Sidekick) and may be predictive and opportunistic, proactively starting conversations, music, games, and so forth (not requiring manual user control for every action). The systems and methods may be context-sensitive (e.g., aware of situations, social atmosphere, and surroundings), may provide for social etiquette of the voice-enabled agent, and may provide varying degrees of user control. The systems and methods may include utilizing personal information and drive histories to learn preferences and interests and adjusting behavior accordingly, and yet may be ready to be used out of the box without a time-consuming set-up.

To recap, some functionalities that may be performed by systems and methods disclosed herein include:

Route Selection: The AI Sidekick can help the traveler decide among the straightest way, the quickest way, the most interesting way, the most scenic way, and the way to include the best lunch break along a trip. Reducing unnecessary information, the system and the AI Sidekick are configured to provide relevant, customized, curated information for the trip.

Helping manage children: The AI Sidekick can help keep children in the car entertained, thereby reducing the cognitive load on the driver. The AI Sidekick can iteratively try different solutions (e.g., music, games, conversation). For instance, the AI Sidekick could initiate the game “20 Questions.” Player One thinks of a person, place or thing. Everyone takes turns asking questions that can be answered with a simple yes or no. After each answer, the questioner gets one guess. Play continues until a player guesses correctly. If the children seem disengaged, the AI Sidekick could move on to a different game or activity.

Social ice-breaker: If desired by the car inhabitants, when there is a lull in the conversation with more than one person in the vehicle, the AI Sidekick may be configured to initiate a conversation by, for example, talking about something in the news, sharing a dilemma, or starting a game. Other features associated with the AI Sidekick may include voice and face recognition to determine the occupant(s) of the vehicle and steer the conversation accordingly. For instance, the AI Sidekick can initiate the pop-culture and news game “Did you hear that . . . ” The game is about fooling your opponents. The AI Sidekick starts by asking “Did you hear that happened?” The car inhabitants can then either say “That did not happen” or “It did happen.” The AI Sidekick can then either confirm it made it up or read the report from its Internet source.

Moodsetting: The AI Sidekick may be configured to set a temperature at which the driver is comfortable and alert enough, a music volume at which the car inhabitants are distracted enough and the driver attentive enough, and a cabin light (e.g., instrument lighting) setting that allows the driver to see enough inside and out.

Companion: The Interactive Chatbot invites a driver to channel his or her emotions without judgement. For example, the driver may need to vent at someone, let out a stream of consciousness, or articulate an idea to hear what it sounds like. The AI Sidekick may be configured to actively listen and remember important details while focusing on the well-being of the vehicle occupant(s). The AI Sidekick may also assist the driver with brainstorming sessions, problem solving, and finding other ways to be creative or productive in the sanctuary of the vehicle.

Custodian: The system may provide information to the driver that helps him to shorten the trip, be safer, or be less hot-headed. The AI Sidekick may detect that a BLUETOOTH signal from an occupant's phone or office keycard is not present when s/he enters the car, at a time when s/he usually has the phone or keycard. The AI Sidekick may then prompt the occupant to check if s/he has it.

Time-management: On an 18-minute drive, the AI Sidekick may be configured to present to the driver an 18-minute music performance. On a 55-minute drive, the driver may be presented with a 55-minute podcast. If a driver arrives 45 minutes before an appointment, the AI Sidekick may direct the driver to a perfect spot to pass the time or provide information to prepare for the appointment as necessary and available.

Documentarian: A driver may have memories attached to important journeys. These memories can be reloaded by hearing the music playing while the driver drove or seeing the scenery they drove past. The AI Sidekick may be configured to record and replay audio, video, and/or photographs of specific trip details (inside and/or outside of the vehicle) and replay them at appropriate times. This could be done for example by an app on a traveler's phone communicating with the system to upload certain photos, videos, and so forth to a database of the system (which may be set to be done automatically in user settings), so that the next time a traveler is passing by the same location the system may offer the traveler the option of viewing the photos, videos, and/or listening to music or sound recordings from the previous trip to or past that location. The traveler may also be able to bring up any important memories by command, such as a voice command to the AI Sidekick to “bring up some memories of last summer's trip to Yosemite” or the like. In implementations and according to the privacy settings desired by users the system could record in-vehicle conversations to be replayed later to revisit memories.

DJ: In conjunction with the Music Compilation service, the AI Sidekick may be configured to present a curated Music Compilation for the driver's entertainment. This compilation may be from a streaming music source or from a private music catalog associated with the vehicle occupant(s).

While most of the features herein have been described in terms of user interaction with the AI Sidekick through audio commands/interaction, or interaction with one or more visual user interfaces on a display of the vehicle, in implementations any user in the vehicle could also interact with the system via a software app on any computing device that is capable of wireless communication with the system. This may be especially useful for example for a person in a back seat who may not be able to reach the visual display of the car but who may be able to, through an app, interact with the system. The same user interfaces shown in the drawings as being displayed on the vehicle display may be displayed (in implementations in a slightly adjusted format for mobile viewing) on any computing device wirelessly coupled with the Trip Brain or the system in general (such as through a BLUETOOTH, Wi-Fi, cellular, or other connection). A user may also use his/her computing device for audio interaction with the system and with the Interactive Chatbot.

The practitioner of ordinary skill in the art may determine how much of the system and methods disclosed herein should be implemented using in-vehicle elements and how much should be implemented using out-of-vehicle elements (servers, databases, etc.) that are accessed by communication with the vehicle through a telecommunications network. Even in implementations which are heavily weighted towards more elements being in-vehicle, such as storing more data in memory of an in-vehicle portion of the system (such as the Trip Brain) and relying less on communication with external servers and databases, interaction with third-party services such as music libraries, weather services, information databases (for the Interactive Chatbot and infographic displays), mapping software, and the like might still rely on the in-vehicle elements communicating with out-of-vehicle elements. Storage of some elements outside of the vehicle may in implementations be more useful, while storage of others in memory of the Trip Brain may be more useful. For example, a map of local, often traversed locations may be downloaded to memory of the Trip Brain for faster navigation (and may be updated only occasionally), while a map of remote locations to which a user sometimes travels may be more conveniently stored offline in database(s) remote to the vehicle or not stored in the system at all but accessed on-demand through third-party mapping services when the system determines that a user is traveling to a location for which no map is stored in local memory of the Trip Brain. In general, the practitioner of ordinary skill can shift some processes and storage remote from the vehicle using remote servers and databases, and some processes and storage internal to the vehicle using local processors and memory of the Trip Brain, as desired for most efficient and desirable operation in any given implementation and with any given set of parameters.

Additionally, a user profile, preferences, and the like may be stored in an external database so that if the user gets in a crash the user's profile and preferences may be transferred to a new vehicle notwithstanding potential damage to the Trip Brain or other elements of the system that were in the crashed vehicle. Likewise if a user purchases or rents a second vehicle the user may be able to, using elements stored in remote databases, transfer profile and preference information to the second vehicle (even if just temporarily in the case of a rented vehicle). The system may also facilitate multiple user profiles, for example in the case of multiple persons who occasionally drive the same car, and may be configured to automatically switch between profiles based on voice detection of the identity of the current driver or occupants in the car.

Systems and methods disclosed herein may include training and implementing an empathetic artificial intelligence (AI) or machine learning (ML) model to help ensure a comfortable driving experience or state of driving. For example, referring to FIG. 1, database 108 and/or other elements of system 100 could include a back-end model and/or ML model which is trained to attempt improvements to a vehicle occupant's state of wellbeing by controlling applications such as vehicle music, a conversation agent, physical conditions (e.g., in-vehicle illumination, temperature, noise levels, humidity, etc.), and so forth. Alternatively or additionally, an ML model could be included in the memory and/or CPU element(s) of FIG. 3, within the vehicle itself, and/or within memory and/or processing elements of an external computing device (smart phone, etc.) located within or proximate the vehicle. Such an ML model may be trained, by non-limiting example, by receiving feedback from a group of travelers (or from one specific traveler) as to what elements help to improve a traveler's wellbeing in a given situation or context. Notwithstanding an ML model being trained in such a way, such an ML model may include one or more parameters or starting values, and the ML model's control of vehicle music, a conversation agent, and/or physical conditions may be kept within the parameters and/or may initially start at or include the starting values. In some implementations, control of

Such an ML model may improve in-vehicle time for a traveler, enabling great improvements in infotainment efficacy through contextual awareness due to information gathered from various sensors. While prior art infotainment options are merely for enjoyment/entertainment and information, such an ML model may help travelers drive safer and easier with less stress, more fun, and greater productivity.

According to one CONSUMER REPORTS survey, only 56% of drivers were very satisfied with their infotainment system. ML models and elements discussed herein allow for solutions to this problem, enabling a step-change in infotainment efficacy through contextual awareness, and allowing in-vehicle time to reach its full potential (or to reach much greater potential). Indeed there is much improvement that may be had. Great Britain's Office for National Statistics monitored over 60,000 drivers and used regression analysis to examine the relationship between driving and personal wellbeing. It identified how time spent driving, and method of travel, affect life satisfaction, levels of happiness and anxiety, and a sense that daily activities are worthwhile. The study found that British spend nearly nine hour per week in a car, with each minute affecting anxiety and overall wellbeing. The study confirmed that driving (particularly commuting) is negatively associated with personal wellbeing and that, in general (for journeys of up to three hours), longer drives are worse than shorter drives for personal wellbeing. This study analyzed personal wellbeing using four measures: life satisfaction, to what extent the respondent felt the things they did in life were worthwhile, whether the drivers were happy, and whether they were anxious. A drop in the first three and a rise in anxiety was indicative of a negative effect on the person's wellbeing.

The above study effectively found that each additional minute of drive time could make a traveler feel worse. Applicant, however, has determined that travelers can derive profound personal benefit from vehicle journeys. This allows the possibility for the vehicle to act as a sanctuary. Time in the vehicle is an opportunity to release emotions a traveler wouldn't allow themselves anywhere else. It is a space where travelers can process thoughts and can feel more themselves when they step out of the car than when they got in. Indeed, people cry more in cars than in any other environment, including the home.

Neuroscientists indicate that the car is a transient, low-vigilance, in-between space, that lets our minds wander and helps us emotionally reset. It serves as a place of refuge. Neuroscientists call the car a task negative space, while other spaces like our workplace or home are on-task spaces. A joint study by HARVARD, DARTMOUTH and the UNIVERSITY OF ABERDEEN discovered that the car is a place to reboot your brain. Being a car traveler lends itself to a cognitive state termed automaticity, freeing the mind to wander. During this state, drivers reported using their travels as opportunities to let their subconscious work on complex problems and take advantage of the meditative nature of drives.

Systems and methods disclosed herein may replace a current array of disjointed software applications, alerts, and infotainment with a delightful, unifying experience. This does not necessarily involve including more software applications and features within a vehicle (or accessible from a vehicle dashboard or user interface), nor providing the largest music catalog. It may, however, involve software applications, sensor data, and other data working together (or being used together) to provide a seamless and pleasurable gestalt. This helps reduce or remove the environmental distress of trips and can help transform the car into a temporary sanctuary.

Empathetic artificial intelligence (“empathetic AI”) has been speculated (such as by a September 2020 WALL STREET JOURNAL article titled “AI's Next Act: Empathetic AI”) as being the “next big thing” and having potential to address bias and generally improve human health and happiness. The article defined empathetic AI as a combination of AI and quantifiable measures of physical and mental state to dabble in quintessentially human territory: reading a situation and addressing what really matters to people. This means interpreting clues to “sense” what a person is trying to achieve at any given moment and helping the person be successful. Empathetic AI could be used, for example, to detect our gender, age, current health, and emotional state to help us meet sleep and nutrition needs and achieve peak cognitive performance, all of which can contribute to more satisfying and healthier lives. Biometric indicators of discomfort, for example, could be used to trigger a thermostat to warm up the house a few degrees.

Systems and methods disclosed herein may utilize a variety of embedded sensors, and location data providing navigational and road condition data, to make the vehicle infotainment contextual, automated, and helpful to a traveler's wellbeing. A vehicle environment may be custom tailored to capture a variety of useful data easily, unobtrusively, and regularly to contribute to the traveler's wellbeing—much more so than the home, the workplace, or any other environment. This can include capturing biometrics, facial expression, body posture, acoustic features, linguistic patterns, and so forth. This can be used alone and/or together with location and traffic data, weather data, calendar entries (such as on a digital calendar), and vehicle on-board diagnostics. Using all of these, an emotional state can be inferred for each traveler, as well as inferring the social dynamic in a vehicle and what the intent of the drive is.

Some advancements in the hearables industry, led by BOSE and DOLBY, use biometric platforms for understanding emotional and physical states. One or more DOLBY systems/devices can detect emotions through measurable physiological changes in people. Levels of carbon dioxide in the breath, thermal imaging, LIDAR tracking of gait and movement, heart rate, pupil size, and other signatures all give off quantifiable indicators of an individual's emotional, mental, and physical state. DOLBY executives believe that people will be using headphones and earbuds to listen to their bodies more than they will listen to music. Their next-generation devices will track people's heart rates, stress levels, blood pressure, and other personal vital signs over time, giving users more input related to their health while providing doctors with valuable data for personalizing treatments and improving outcomes. Wearables, hearables, and sensors embedded in hardware such as smart speakers may soon enable other spaces and environments to offer context-based features. The systems and methods disclosed herein, however, allow for context-based features in a vehicle.

Driver assist features, such as autonomous driving features, will help reframe the driver as a traveler. Previously the vehicle industry had to focus the in-vehicle experience on keeping the driver on task for safety reasons (from annoying seat belt chimes to warning lights and alerts). Driver assist features will allow the systems and methods disclosed herein to focus on the wellbeing of the driver, as well, allowing the vehicle to be, as AUDI claims, a third living space. ML models such as those disclosed herein may include and/or involve empathetic AI to support what makes a vehicle traveler human, not just to support their focus on driving—such as removing environmental inconveniences of the driving experience and otherwise assisting with the wellbeing of the traveler.

The above-referenced WALL STREET JOURNAL article linked empathetic AI primarily to a dramatic improvement in personalization, stating that the use of this new tech results in “a palpable philosophical shift to make technology map much more closely to each user . . . Empathetic technology is poised to enable a completely new generation of highly personalized, AI-driven products and services that we haven't even begun to imagine.” Yet personalization may have reached its limits along with the glorified discipline of Human-Centered Design.

When Human-Centered Design first appeared as the new mindset in product design, it radically overhauled an approach stuck in the past and introduced new tools and skill sets to create the right kind of relationship with users at the time. In an influential TED talk, IDEO's Tim Brown described his own part in the diminishing importance of traditional design: “[I was] making things more attractive, making them a bit easier to use, making them more marketable . . . I was being incremental and not having much of an impact [as a result of] design becoming a tool of consumerism.”

Through the introduction of Human-Centered Design (aka Design Thinking), the discipline regained its importance and impact. It was a radically new approach that spread quickly from tech to all marketable goods as well as health care and education. The term first appeared at the Netherland's DELFT UNIVERSITY OF TECHNOLOGY in the early 1990s, but it was really STANFORD's D.SCHOOL and IDEO that championed the theory, and APPLE that showed its power in practice. At its core, design thinking brought humanity back to product design. It was the victory of the intuitive, crowd-pleasing empath over the emotionless, task-obsessed engineer—in the personification of Steve Jobs. Shortly after he passed away, John Gage, a co-founder of SUN MICROSYSTEMS and friend of Jobs since their HOMEBREW COMPUTER CLUB days, defined Jobs's legacy: “He saw clearly how to take this enormous complexity and make something a human being could use.” This is the core of Human-Centered Design. Jobs always put users above engineering convenience, anticipating their needs and desires before they realized so themselves.

When APPLE launched the IPAD 2, he drove the point home in his keynote: “Technology alone is not enough. It's technology married with liberal arts, married with the humanities, that yields the results that make our hearts sing.” As much as Jobs lived and breathed human-centered design, this mindset was unique amongst his pioneering tech peers. According to THE ECONOMIST, his success partly happened because in an industry dominated by engineers and marketing people who often seem to come from different planets, he had a different and much broader perspective. Jobs had an unusual knack for looking at technology from the outside, as a user, not just from the inside, as an engineer—something he attributed to the experiences of his wayward youth. “A lot of people in our industry haven't had very diverse experiences,” he once said. “So they don't have enough dots to connect, and they end up with very linear solutions.” Bill Gates, he suggested, would be “a broader guy if he had dropped acid once or gone off to an ashram when he was younger.”

The discipline of human-centered design, while industry-transforming at its peak, may have reached its limits. Music streaming may be used as an example to highlight the shortcomings of human-centered design. A key result of the human-centered approach has been personalization. Music streaming benefited greatly from the ability to gear music listening to personal taste and other preferences. But it remains imperfect. A well-kept secret in music streaming is that despite fine-tuned algorithms and data-scientific models, listeners still skip, on average, half the songs chosen for them. This astonishingly high number of skips results from a design process that focuses entirely on the user, but not on the product itself (in this case the song), nor on any external factors. Human-centered design helped establish music streaming as a major industry, yet it could not evolve the category further.

If the Digital Service Providers (DSPs) had taken song structure in consideration as well, playlisting would have improved, likely leading to much lower skip rates. In the industry there is no arrangement to playlists other than theme. By understanding harmony, beat and tempo of each particular song, play listing could become so much more deliberate, intentionally progressing song selection at the right pace and in a compatible key, creating a powerful flow to the overall experience. Yet the biggest oversight of the DSPs results from flawed thinking; a flaw inherent in the concept of personalization: taste and preferences are not static. They are dynamic and variable.

In a landmark study, the Swedish musicologist Carin Öblad discovered that music listening follows a dual-loop process. In other words, the activity is initiated by both external and internal motivations that mediate our music choices. Human-centered design and the personalization of services don't prioritize context, the external motivation referenced by Professor Öblad. Case in point, a person will likely prefer different music when sitting alone on their living room sofa with a beer in their hands after a hard day of work, than while driving their twelve-year old daughter to school in the morning. Yet, the DSP's playlists remain static and linear; they are the same no matter where, when, and with whom the user is listening. The personalization of digital music has, ironically, turned out to be rather impersonal.

Music listening, like many other activities, is context dependent. If a DSP were to be able to place every stream into the context of each particular situation and circumstance, that service would truly develop an intimate connection with the listener. Context is the next evolution. It relates personalization to the overall situation and circumstance. It transforms any experience into something intimate and useful. Human-Center Design alone could not achieve that, because crucial factors affecting usage were not prioritized. Context-based design is an emerging paradigm where usage context is considered as a critical part of driving factors behind people's choices. It still focuses on the human, but places them within the relevant situation.

Bill Gates famously published a white paper on MICROSOFT's home page in 1996 titled “Content is king.” The new media guru Gary Vaynerchuk recently remarked that “if content is king, then context is god.” That is because context has the ability to transform digital content into intuitive, curated media. Personalization caters to personal taste and preferences but can deliver an inadequate experience because taste and preferences are dynamic and variable. Contextualization, on the other hand, relate personalization to the overall situation and circumstance and transform the experience into something truly intimate and useful. The systems and methods disclosed herein are configured for contextualization of this form, not just personalization, because they gather and determine information related to the context of travelers in a vehicle.

Empathetic AI may become the “new normal” in luxury cars. The industry is currently in an arms race to deliver sensor technology and software that can detect nuanced human emotions, complex cognitive states, activities, interactions, and objects people use. TESLA, TOYOTA and FORD are just three of the prominent car makers who appear close to a breakthrough, while Tier 1s like APTIV (through its investment in AFFECTIVA) are investing heavily in the technology. A key reason is that people simply expect it. With the ubiquity of mobile devices and information at their fingertips, people assume the same experience in their cars. They want an in-cabin environment that's adaptive and tuned to their needs in the moment. Yet there are still several challenges to conquer, such as Big Data “analysis paralysis” and mood detection accuracy.

In the age of Big Data, we can easily get overwhelmed with the amount of data we collect. It is a problem experts have termed “Analysis Paralysis.” We can collect all kinds of passenger data in the car and augment it with social media data and marketplace data. The opportunities are endless, and so are the dangers. Flooding a database with non-essential data can overwhelm a system (or its creators) and deem analysis meaningless.

Big Data is defined by the five Vs: volume, velocity, variety, value, and veracity. One software/IT challenge is how to manipulate this vast amount of data that has to be securely delivered, reach its destination intact, and applied in real-time to support the passenger. It boils down to which data is actually valuable; useful for our specific purpose and not needing “clean up.” The idea of hardcore focus is not novel in tech. But, despite decades of success stories in its application, the industry still falsely romanticizes the “more is better” dogma.

With regards to mood detection, emotions are inherently difficult to read. AI is not yet sophisticated enough to understand cultural and racial differences. For instance, a smile may mean one thing in Germany and another in Korea. Furthermore, pinpointing the many nuanced types of emotions without interaction and follow-up probes can be misleading (e.g., disgust). Perceiving the differences between similar emotions is not the only challenging part. People usually experience a range of emotions, all at once or in short order, making the task of mood detection even harder.

However, there has been progress. Multimodality (e.g., combining macro and micro facial expressions, combining biometrics and facial coding) has increased accuracy to nearly 80% and to even over 90% for key emotions. As with any machine learning and Big Data system, our capacity to capture a baseline for each regular passenger will only increase comprehension further.

With regards to facial recognition, it has been the go-to measurement for the Human Perception AI industry. That makes sense for psychotherapy, athletic performance, new work, and media analytics. The face provides a rich canvas of emotion and humans are innately programmed to express and communicate emotion through facial expressions. However, in or on a vehicle (e.g., in a car), facial expression is not a reliable indicator of emotion. The traveler's primary focus lies on the road and operating the vehicle, not on expressing their affective mood. That makes the interpretation of facial expressions, head orientation, and eye movements often misleading. In a car, multimodal analysis must rely on more sensors and measurements than in other environments to overcome the situational limitations of facial recognition.

Challenges to data collection may be overcome by: focusing on a lean data set; going even beyond multi-modal into a holistic data analysis; and simplifying mood analysis.

Empathy is about understanding and supporting the traveler. This may involve pinpointing in-vehicle context with high accuracy. The automotive industry, as much as any other industry, tends to fall into two traps when it comes to Big Data and its applications: capturing as much data as possible; and placing too much focus on monetization and marketplace applicability. In-vehicle empathetic AI is about being a wellbeing resource in the car to ensure a comfortable state of driving (and functioning). In implementations the systems and methods disclosed herein may work accurately and in real-time by only capturing data that is truly useful in the endeavor, and not being seduced into adding unnecessary complexity.

The systems and methods disclosed herein may involve or include empathetic AI and may be configured to shape every kind of car trip deserves its own experience. Accordingly, one major built-in design constraint or parameter may be as follows: the experience may be determined by the trip and its specific qualities. Based on this philosophy, there may be six major qualities of context that define a trip, as defined above (trip progression, intent, social dynamic, state of mind, trip conditions, and regularity of the trip). By narrowing data collection to these six characteristics, the volume, velocity, variety, value, and veracity of the data may be optimized.

While emotions are inherently difficult to read, as indicated above some progress has been made. Multimodality (e.g., combining macro and micro facial expressions, combining biometrics and facial coding) has increased accuracy to nearly 80% and to even over 90% for key emotions. However, the systems and methods disclosed herein may go beyond multimodality into a holistic trip analysis to truly gain clarity. In order to understand the cause and effect of one's emotions, the systems and methods may consider, analyze and comprehend all six critical characteristics of each drive, as described above. For example: a sudden spike in arousal, coupled with a significant drop in valence is clarified when also considering the on-board's detection of sudden de-acceleration and heavy use of the brakes, coupled with the ambient noise detection of screeching tires, and the acoustics of an expletive uttered by the driver, while shifting in body position.

Referring again to FIG. 3, in implementations biometric sensors and vehicle sensors are included in the system 100. Biometric sensors and vehicle sensors could include (but are not limited to) the following: pulse sensors; breathing rate sensors; body temperature sensors; oxygen saturation sensors; degree of blood flow sensors; oxytocin level sensors; steering wheel grip and angle sensors; galvanic skin response sensors; electrocardiogram (ECG) sensors; skin conductance sensors; heartrate sensors; blood pressure sensors; perspiration sensors; movement or motion sensors; one or more cameras; one or more microphones; and so forth. Some of these biometric sensors could be built into or incorporated in the vehicle itself (such as pulse testing built into a steering wheel), while some of the biometric sensors could be external but communicatively coupled with the vehicle (such as gathered from a smart watch, a smart ring, a smart bracelet, etc.). Such sensors may measure a traveler's vital signs and may be used by system 100 to infer psychological and physiological arousal, state of flow, and brain activity. The practitioner of ordinary skill in the art will know how to select appropriate biometric sensor types to sense/determine desired biometric information about travelers.

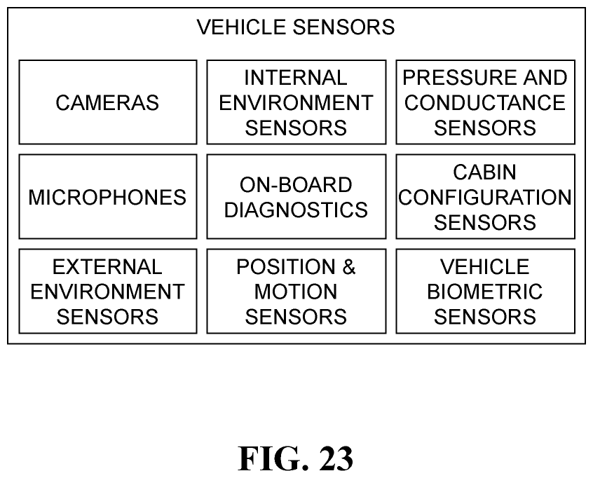

Referring now to FIG. 3, it is seen that the trip brain 302 may communicate with one or more vehicle sensors to accomplish certain methods. FIG. 23 shows that the vehicle sensors may include, by non-limiting example, one or more cameras, internal environment sensors, pressure and conductance sensors, microphones, on-board diagnostics, cabin configuration sensors, external environment sensors, position and motion sensors, and vehicle biometric sensors. Each of these sensors and sensor types could be part of the vehicle itself and/or could be simply communicatively coupled with the vehicle if not part of the vehicle itself. In implementations all of the elements of FIG. 3 (apart from external computing device 300) could be part of the vehicle 122 of FIG. 1.

Cameras could include light sensors to determine illumination level, infrared sensors to determine heat or temperature levels, cameras to determine pupil size, and so forth. Pressure sensors could be located in seats, in a steering wheel, and so forth. Conductance sensors could be located on a steering wheel. Pressure and/or conductance sensors in/on the steering wheel could determine or help determine a user's grip pressure and/or position/angle of hands, and so forth. Internal environment sensors could determine cabin temperature, pressure, oxygen level, humidity, olfactory sensors to determine smells, and so forth. External environment sensors could determine external temperature, weather conditions, air pressure, lighting, and so forth. Position and motion sensors could include accelerometers, global positioning satellite (GPS) and other position sensors, gyroscopic sensors to determine pitch/angle of the user and/or vehicle in any three-dimensional (3D) direction, and so forth. Cabin configuration sensors could include sensors to determine position settings of seats, volume settings of audio, lighting settings within the cabin, window positions within the cabin, air conditioning and/or heating settings within the cabin, seat warmer/cooler settings, and other settings within the cabin. The practitioner of ordinary skill in the art will know how to select appropriate sensor types to sense/determine desired information related to the vehicle, its cabin, vehicle settings, and so forth.

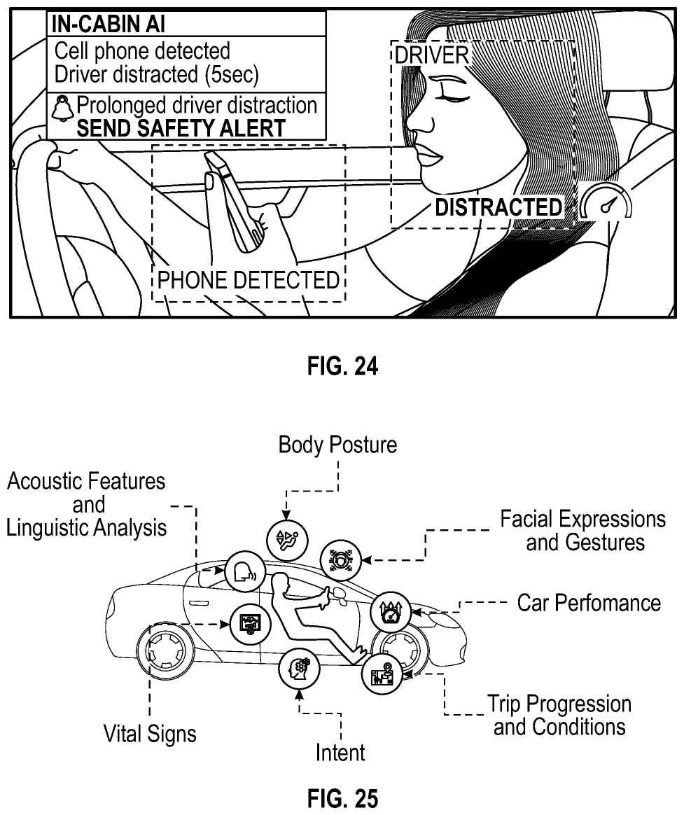

Cameras (of the vehicle and/or of a user's phone or other computing device, communicatively coupled with the vehicle), could measure macro and micro facial expressions. This can include (but is not limited to) the following data types: eye flutter, gaze, smile level, facial muscle activation, head movement, and potential focus on NFC objects (or, in other words, objects communicatively coupled with the vehicle through a near-field communication coupling or another communicative coupling). FIG. 24 representatively illustrates, for example, that in-cabin AI or the aforementioned machine learning model may detect, using a variety of sensor inputs including cameras and NFC sensors and so forth, that a cell phone is present, that the driver has been looking at the cell phone for five seconds and is accordingly distracted, and that a safety alert should be sent to the driver. The driver may then be sent such an alert, by an audio and/or visual notification in the cabin, or on the phone (such as through the use of an associated installed software app on the phone configured to display a notification over the user's current screen/interface), or so forth.

In implementations biometric and vehicle sensor information may be used by the ML model to determine or infer three emotional criteria: alertness, valence, and arousal. They may similarly be used by the ML model to determine level of engagement, level of distractedness, and state of flow. As indicated above, relying solely on facial analysis may not be as useful, but facial analysis may be a useful component of a holistic analysis. Detection of a smile, a furrowed brow, tightened eyelids, a raised chin, a sucked lip, an inner brow raise, a lip corner depression, a lip stretch, and so forth, may be indicators of specific emotions. The system may, using the ML model and/or administrator input, map facial expressions to various emotions.

As indicated above, vehicle sensors may include pressure sensors. In implementations, seat pressure sensors may measure body posture and/or may provide the following data types: body activity and direction leaning (i.e., a direction in which the traveler is leaning). Such information may be used by the system and/or ML model to determine or infer driver engagement, arousal and alertness. Microphones may be used to measure acoustic features, ambient noises, and to allow the system and/or ML model to conduct linguistic analysis. Microphones may provide or facilitate the following data types: vocal parameters and fluency, and tone and sentiment extraction. The system and/or ML model may use this data to determine or infer valence, arousal, alertness, state of flow, the social dynamic in the car, and strength of social connection(s) amongst the passengers.

Vehicle sensors may include on-board diagnostics which measure or determine the car's or vehicle's performance. This may include (but is not limited to) the following data types: vehicle speed (and the delta vs. the speed limit), acceleration, cabin temperature, and so forth. Such data may be used by the system and/or ML model to determine or infer the effect or correlation of such vehicle factors to the traveler's alertness, arousal, and so forth.

Vehicle sensors may gather data related to GPS position, weather, trip progression, and trip conditions. They may provide the following data types: evolution of trip, duration, types of roads, toll markers and other notable markers, traffic conditions, weather, time of day, traveler familiarity with route, and so forth. The system and/or ML model may use such data to determine or infer the effect of such factors on traveler alertness and arousal.

In implementations, a combination of GPS (start and end points) data, calendar entry, time of day, pattern, and social dynamic in the car may be used by the system and/or ML model to determine or suggest an intent of a trip (in other words, the trip's purpose, such as a commute, errand, road trip, trip to a meeting, and so forth).

FIG. 25 representatively illustrates data that may be gathered by various sensors (vehicle sensors and/or biometric sensors) and analysis that the system and/or ML model may perform based on such data, including determining body posture, facial expressions and gestures, car performance, trip progression and conditions, traveler vital signs (biometric information), acoustic features, and so forth. The system and/or ML model may perform linguistic analysis and may otherwise analyze the sensed information/data to determine a trip intent and to provide a variety of other services/features, such as tailoring audio/music and/or interactive conversation agent features to the determined emotional or mental state of the traveler(s). FIG. 25 only shows some representative examples of gathered data and/or system/model determinations, and is not exhaustive.

Table 1A below gives additional details on data that may be gathered by sensors and/or analyzed by the system and/or ML model to make determinations as to mental state, alertness, valence, arousal, and so forth. This table is an example taken from the following publication which is incorporated herein by reference: “Technical Design Space Analysis for Unobtrusive Driver Emotion Assessment Using Multi-Domain Context,” David Bethge et al., Proc. ACM Interact. Mob. Wearable Ubiquitous Technol., Vol. 6, No. 4, Article 159, published December 2022. Systems and methods disclosed herein may use or include any other details or characteristics disclosed in this reference, which reference is disclosed in conjunction with an information disclosure statement associated with this application.

TABLE 1A
Data Collection Details

| Context | Feature | Details |
|---|---|---|
| Reference Data | frame_number | The number reference for the session snapshot |
| | timestamp | frame pair, e.g., 21/10/15, 18:55:39:0025. |
| | audio_file_path | p_01/session_id/audio.mp4 |
| | front_frame_path | p_01/session_id/imgs/front_frame_501.jpg |
| | back_frame_path | p_01/session_id/imgs/back_frame_501.jpg |
| Personal | sex | male, female, other |
| | car_model | e.g., VW Polo, Porsche Taycan |
| | age | Participant's age. |
| | participant_id | e.g., p_01, p_02 |
| | emotion_before | Emotion before ride. |
| Session | session_id | e.g., 0751B8E9-3357-47E3-A862-CBFC60B88555 |
| | session_start | e.g. 21/10/15, 18:54:49:0015 |
| | session_end | e.g. 21/10/15, 19:14:69:0485 |
| Session Time | weekday | Mon. Tue. Wed. Thurs. Fri. Sat. Sun. |
| | daytime | Morning, Afternoon, Evening, Night |
| Motion | acceleration_x | Acceleration on the x axis. |
| | acceleration_y | Acceleration on the y axis. |
| | acceleration_z | Acceleration on the z axis. |
| | vemotion_acceleration | (or acceleration_v1) Acceleration as in VEmotion. |
| GPS | speed | Vehicle speed in km/h. |
| | latitude | Latitude value of current location. |
| | longitude | Longitude value of current location. |
| Traffic Data | current_travel_time | Current travel time in seconds. |
| | free_flow_speed | Free flow speed expected under ideal conditions. |
| | current_speed | Current average speed at the selected point. |
| | free_flow_travel_time | Travel time (secs) under ideal free flow conditions |
| | reduced_speed | Calculated by free_flow_speed minus current_speed |
| Weather Data | wind_speed | Outside wind speed in km/h. |
| | precipitation_24h_mm | Rain fall measurement in millimeters. |
| | feel_temp_outside | “Feels like” temperature in Celsius. |
| | cloud_cover | Percent representing cloud cover. |
| | weather_term | e.g., cloudy, mostly cloudy, mostly sunny, sunny |
| Road Data | road_type | e.g., cycleway, footway, living_street, residential. |
| | max_speed | Max allowed speed for current road. |
| | num_lanes | Count of available lanes on the road. |
| Facial Expression | facial_expresssion_label | Front-facing camera's classified emotion. |
| Prediction | | |
| Perceived Emotion | label | Emotion expressed by party during experiment. |
| Audio | audio_amplitude | Audio amplitude avg for duration of chunk. |
| | audio_loudness | Audio recording avg loudness for duration of chunk. |
| | audio_zero_crossings | Audio zero crossing rate of correspondent chunk. |
| Visual Complexity | num_cars, num_people, | Num. of objects detected in the back-facing camera |
| (Object Detection) | bicycles, pedestrians, | frame per class. |
| | motorcycles, buses, trucks, | Num. of objects at estimated distances from |
| | traffic_lights, traffic_signs | camera. |
| | num_med_close_objs, | |
| | num_very_close_objs, | |
| | num_close_objs, | |
| | num_very_far_objs, | |
| | num_far_objs | |
| Visual Complexity | road, sidewalk, building, | Percentage pixels in back-facing frame representing |
| (Segmentation) | wall, fence, pole, traffic | class. |
| | light, traffic sign, | |
| | vegetation, terrain, sky, | |
| | person, rider, car, truck, | |
| | bus, train, motorcycle, | |
| | bicycle | |

A combination of human, circumstantial, and environmental data can determine the context of a trip, and may be used by an ML model or empathetic AI to provide contextual interventions for wellbeing and safety. As examples, and referring again to FIG. 25, Table 1B gives, for a plurality of data categories: data sources, data types, and inferences made by the system based on the gathered data. Any of the data sources may themselves be components of the system of FIG. 1.

TABLE 1B
Example Data Categories, Sources, Types, and Inferences

| Data Category | Data Source | Data Type | Inferences |
|---|---|---|---|
| Acoustic Features | microphone | vocal parameters, | alertness, valence, |
| and Linguistic | | fluency, tone and | arousal, state of |
| Analysis | | sentiment | flow, social dynamic |
| | | extraction | in vehicle, strength |
| | | | of social connection |
| | | | among passengers |
| Body Posture | Seat and steering | body activity, | engagement, |
| | wheel pressure | direction of leaning, | arousal, alertness |
| | sensor | grip | |
| Facial Expressions | camera | macro and micro | alertness, valence, |
| and Gestures | | expressions, eye | arousal, level of |
| | | flutter, gaze, smile | engagement or |
| | | level, facial muscle | distractedness, |
| | | activation, head | expressiveness, |
| | | movement, focus | state of flow |
| | | on NFC object | |
| Car Performance | on-board | destination, speed | situational effect on |
| | diagnostics | (vs. speed limit), | driver alertness and |
| | | acceleration, | arousal |
| | | temperature | |
| Vital Signs | biometric sensors, | pulse, breathing | psychological and |
| | ECG skin | rate, body | physiological |
| | conductance sensor | temperature, | arousal, state of |
| | | oxygen saturation, | flow, brain activity |
| | | degree of blood | |
| | | flow, oxytocin | |
| | | levels, steering | |
| | | wheel grip and | |
| | | angle, galvanic skin | |
| | | response | |
| Intent | GPS (start and end | determination of | situational effect on |
| | points), calendar | purpose (e.g., | driver alertness and |
| | entry, time of day, | commute, errand, | arousal |
| | pattern, social | road trip, trip to a | |
| | dynamic | meeting) | |
| Trip Progression | GPS, weather, | evolution of trip | situational effect on |
| and Conditions | microphone | (duration, types of | driver alertness and |
| | | roads, notable | arousal |
| | | markers such as toll | |
| | | markers), traffic | |
| | | conditions, | |
| | | weather, time of | |
| | | day, familiarity with | |
| | | route, ambient | |
| | | noise | |

Various genres of driving may be classified. To some extent there is no such thing as a standard trip. Each trip in the car is unique, characterized by unique qualities. A drive alone to work creates a completely different dynamic in the cabin than a drop-off of the driver's daughter at her middle school. These may entail different speeds, mindsets, in-vehicle atmosphere, and so forth. The system and/or ML model may accordingly select very different music to incorporate into a playlist and/or to otherwise play using the infotainment system. Even if the driver is alone in the car (which is the predominant traveler situation today), there are still major differences that go beyond in-vehicle social dynamics (e.g., alone vs. with daughter) and intent (e.g., commute vs. drop-off). Every trip deserves its own bespoke experience, and that experience is determined by system and/or ML model after determining/identifying the type of trip and its specific qualities.

With regards to classifying the trip type, such classification may in implementations involve grouping objects together based on defined similarities such as subject, format, style, or purpose. Genre classification as a means of managing information is already well established in music (e.g. folk, blues, jazz), but also is used in retail settings, for instance in book stores where there is a children's section, a fiction section, a business section etc. In automotive/vehicle settings, the characterization of information using “genre” is not a well-defined notion.

In implementations, classifying the type of drive may facilitate the system and/or ML model intuitively automating audio content and physical conditions in the car. This may allow for an empathetic AI system within the vehicle. As indicated above, every trip may deserve its own bespoke experience, and that experience may in implementations be determined by the system and/or ML model using the type of trip and its specific qualities.

Different states of driving may be classified. One benefit of in-vehicle empathetic AI is the improved wellbeing of the travelers. As indicated above, wellbeing as it relates to driving involves a traveler's state of functioning. In-vehicle empathetic AI may be facilitated by determining various states of driving. In implementations driving states may be categorized into four types, each of which may be a subset of comfortable driving. The specific driving state may in implementations depend on the situation, the internal and external environment, and in-vehicle dynamics. The four types in implementations are observant driving, routine driving, effortless driving, and transitional driving.

The state of observant driving is defined by the extra caution the driver is expected to attend to, such as when challenging road and traffic conditions (e.g., heavy traffic), bad weather, and/or an unfamiliar locale require intense focus on navigation. Examples are a traffic jam or rush hour drive. Observant driving requires extra focus on navigation and traffic conditions. Observant driving can in implementations be defined as driving in which one or more of the following are detected or determined to be present or to be upcoming: a traffic slowdown of a predetermined threshold below a speed limit; a calculated traffic jam factor beyond a predetermined threshold; rain; snow; fog; wind speed above a predetermined threshold; temperature beyond a predetermined threshold (for example below a preset low temperature or above a preset high temperature); driving between a predetermined time range; driving during a predetermined rush hour time range; driving a threshold amount beyond a speed limit (such as 10 MPH above a speed limit or 10 MPH below a speed limit); a structural obstruction; a toll location; light conditions beyond a predetermined threshold (for example luminosity or illumination below a predetermined amount or level or luminosity, or illumination above a predetermined amount or level in the driver's field of view such as the sun in the driver's eyes); a driving location the driver has not previously traversed; and a driving location the driver has traversed below a predetermined amount of times. These are only non-limiting examples and this list is not comprehensive.

The state of routine driving is defined by the mundaneness of the drive such as when familiar, often shorter, trips let the driver think of the tasks ahead or focus on the in-cabin music. Examples are routine errands, commutes to work, and drop-offs. Such driving lets the traveler/driver focus on things besides safe driving. Routine driving can in implementations be defined as driving in which one or more of the following are detected or determined to be present or to be upcoming: a total estimated travel time below a predetermined time limit; a driving location the driver has previously traversed; a driving location the driver has previously traversed a threshold number of times; a total trip mileage below a predetermined threshold; mileage of a portion of the trip below a predetermined threshold (for example a freeway portion of the trip being below five miles); travel time of a portion of the trip below a predetermined threshold (for example a freeway portion of the trip being below ten minutes); a commute to work; absence of rain; absence of snow; absence of fog; wind speed below a predetermined threshold; light conditions beyond a predetermined threshold (for example above a predetermined luminosity or illumination amount, or light above a predetermined luminosity or illumination amount not being in the driver's field of view); and a drop off of a passenger. These are only non-limiting examples and this list is not comprehensive.

The state of effortless driving is defined by the way the driver may be mindful. Examples are commutes, empty highways, and road trips. Such trips are uncomplicated, often routine, trips, with favorable road and traffic conditions that let one think about the tasks ahead or reboot one's brain. Effortless driving can in implementations be defined as driving in which one or more of the following are detected or determined to be present or to be upcoming: a commute having an expected mileage above a predetermined threshold; a commute having an expected travel time above a predetermined threshold; traveling on a highway; traveling on a freeway; traveling on an interstate; a total expected travel time beyond a predetermined amount of time; expected travel time for a trip portion (for example travel time only on a freeway or interstate portion of a trip) beyond a predetermined amount of time; a driving location the driver has previously traversed; a driving location the driver has previously traversed a threshold number of times; a vacation-related trip (for example starting or ending a vacation as determined by calendar events or by other mechanisms); an absence of a traffic slowdown of a predetermined threshold below a speed limit; a calculated traffic jam factor within a predetermined threshold; an absence of structural obstructions; a lack of toll locations; absence of rain; absence of snow; absence of fog; temperature above a predetermined threshold; temperature within a predetermined range; temperature below a predetermined threshold; wind speed below a predetermined threshold; light conditions beyond a predetermined threshold (for example luminosity or illumination above a certain threshold but without sun or the like in the driver's eyes or field of view); driving within a predetermined time range; a consistent or constant speed limit for a predetermined amount of time or mileage; and driving outside of a predetermined rush hour time range. These are only non-limiting examples and this list is not comprehensive.

The state of transitional driving is defined as “let-your-guard-down” trips. Examples are the commute home from work, drives to dinner, or drives to hobby-related activities (e.g., athletic practice, the art studio, etc.). These trips let the traveler transition from one persona to another (for instance from boss at work to wife and mom, from engineer to soccer team-mate, etc.) and let their guard down.

Transitional driving can in implementations be defined as driving in which one or more of the following are detected or determined to be present or to be upcoming: a commute home; an estimated amount of time or mileage, to a determined end location from a present location, below a predetermined threshold (for example within five miles or within fifteen minutes of home, or a yoga studio, or a grocery store); and a determination of a different activity type at the end location relative to an activity type at a starting location (for example using calendar entries or machine learning based on past behavior to determine that the driver is leaving work to go to the gym (a transition from work to exercise), or leaving the gym to go to a restaurant (a transition from exercise to eating), or leaving home to go to work (a transition from relaxing to working), or leaving work to take a lunch break (or returning from a lunch break to work), and so forth. These are only non-limiting examples and this list is not comprehensive.

Each of these different states of driving may involve different functioning, and different methods/mechanisms may be used by the system and/or ML model to improve or help the traveler's wellbeing. A desired mental state during observant driving may be cautious, with heightened perception, but not apprehensive. The focus in such situations may be extra safety. In order to achieve that the driver may need to stay calm rather than becoming apprehensive (which could result in overreaction).

A desired mental state during routine driving may be the traveler being at ease, with alert consciousness. In these situations the driver knows what they are doing. While they must remain alert to traffic conditions, they can do so with less poise.

A desired mental state during effortless driving may be the traveler being serene (physically and mentally relaxed). In driving situations that require less focus, the driver can let their subconscious go to work.

A desired mental state of transitional driving may be the traveler being forward looking (excited consciousness). In these driving situations, the focus may lie on preparing the traveler/driver for their next role—to use the drive as a liminal phase from one persona to the next, and prepare for and anticipate what comes next.

As discussed, an ML model of the system may include or comprise empathetic AI to improve a traveler's driving/passenger experience and overall wellbeing. Such an ML model may be configured to encourage or elicit optimal brainwaves and emotions of targets (drivers and passengers) during travel and/or for overall wellbeing. The driving classifications discussed above may determine or affect the ML model configuration. Each of the four defined core states of driving may benefit from a distinctive state mind in the driver/passenger(s), and the ML model and system may encourage, elicit, or support by altering/controlling physical conditions in the vehicle and/or altering/controlling specific applications within or configurations of the infotainment system.

For each of the above-defined states of comfortable driving, the system and/or ML model may have a predetermined corresponding brainwave and/or emotional state target. For brainwaves, the system and/or ML model may have target frequency ranges for the different driving states.

For example, during observant driving the brainwave target may be in the lower Gamma range, such as 32-50 Hz. In that range it is expected that a driver would have heightened perception and heightened cognitive processing to help them drive safer in difficult traffic. During routine driving, the brainwave target may be in the lower Beta range, such as 13-20 Hz. In that range it is expected that the driver will achieve alert consciousness, which may help put them at ease. During effortless driving the brainwave target may be in the lower Alpha range, such as 8-11 Hz. In that range it is expected that the driver will become physically and mentally relaxed, which will help their minds wander and mentally recharge. During transitional driving, the brainwave target may be in the upper Beta range, such as 20-30 Hz. In that range it is expected that the driver will achieve excited consciousness, which helps them look forward to their next role.

Although the above examples discuss target brainwave ranges for drivers, in implementations the system and/or ML model may focus on affecting the brainwaves of passengers as well or alternatively. In some cases the system and/or ML model may prioritize the brainwave ranges of drivers, to ensure safe driving, but the system and/or ML model may also attempt to affect brainwaves of passengers independently. This could involve, for example, adjusting the seat temperature and/or AC/heating and/or lighting in a passenger area differently than in the driver area, to accomplish different brainwave targets for a passenger versus a driver, based on a determined approach more likely to improve wellbeing for a specific passenger or set of passengers versus a driver. In some cases the system and/or ML model could prioritize the wellbeing of a passenger. For example if the system determines that a specific passenger is upset, while the driver is determined by the system to not be upset (or not be as upset), the system may prioritize affecting the brainwave range and/or emotions of the passenger, to attempt to calm down the upset passenger and achieve a more peaceful or positive atmosphere in the vehicle. The system may react differently when determining that vehicle occupants are arguing, or that one or more vehicle occupants is crying or otherwise showing strong emotions, to support overall wellbeing for drivers and passengers.

In some cases the system may actually measure brainwave activity with sensors to receive feedback and/or to determine if the brainwave targets are being achieved. For example, the system may include a hat or unobtrusive headpiece to be worn during driving, the hat or headpiece including brainwave sensors for input/feedback to the system and ML model to help the system and ML model to more easily reach the target brainwave frequency range. In some cases, however, the system may exclude such sensors and may attempt steps which are likely to achieve the desired brainwave frequency ranges, but without actually knowing whether the brainwave frequency ranges are received. The system may determine, however, based on circumstantial evidence from other sensory inputs (such as tone of voice, sitting position, eye movement, heart rate, etc.), whether the brainwave frequency has likely been reached, by using known or determined correlations between brainwave frequency ranges and such physical details.

The system and/or ML model may have certain emotion targets for drivers and/or passengers. In some cases precise emotion detection may not be needed in order to satisfactorily achieve traveler wellbeing, as will be detailed below. However, precise emotion detection may be undertaken in some circumstances.

For background, it is pointed out that in psychology “valence” is an affective quality referring to the intrinsic attractiveness/“good”-ness or averseness/“bad”-ness of an event, object, or situation. Emotions popularly referred to as “negative,” such as anger and fear, have negative valence. Joy has positive valence. Valence measures the nature of a person's experience; whether a person is in a pleasant (e.g., happy, pleased, hopeful) or unpleasant (e.g., annoyed, fearful, despairing) state.

In psychology “arousal” is a physiological and psychological state of being awake. It involves the activation of the reticular activating system in the brain stem, the autonomic nervous system and the endocrine system, leading to increased heart rate and blood pressure and a condition of sensory alertness, mobility and readiness to respond. During an actual awake state a person can have varying levels of arousal. Arousal measures how calm or soothed versus excited or agitated a person is.

In psychology, alertness is the state of paying close and continuous attention. It is the opposite of inattention, which is failure to pay close attention to details or making careless mistakes when doing work or other activities, trouble keeping attention focused during tasks, appearing not to listen when spoken to, failure to follow instructions or finish tasks, avoiding tasks that require a high amount of mental effort and organization, excessive distractibility, forgetfulness, frequent emotional outbursts, being easily frustrated and distracted, and so forth. Alertness measures the state of active attention and awareness; how watchful and prompt a person is to meet danger, or how quick they are to perceive and act.

As used herein, the terms valence, arousal, and alertness have the meanings and/or definitions given above. For the purposes of this disclosure, it is pointed out that emotions with similar valence, arousal and alertness produce analogous influence on state of mind, choice and judgment.

In implementations, in order to affect and/or control in-vehicle experiences and wellbeing, the system and/or ML model only needs to adjust or scale these three affective qualities of valence, arousal, and alertness. For example, for the purpose of supporting a traveler functionally and/or emotionally, in implementations the AI does not differentiate between, let's say, anger and fear. Thus, in such implementations the system does not do emotional determination rising to the level of a psychotherapy session, but instead the infotainment system may be used to help make the traveler more comfortable and support their functioning by simply detecting a high arousal state (which may be anger or fear or any other high arousal state) and helping to counteract that. This method of simplifying mood analysis may, in implementations, increase the system's accuracy and effectiveness for its specific purposes. For example, the system may be able to detect and counter high arousal states more accurately and quickly than determining which high arousal emotion is occurring and countering that specific emotion. This is just one example, and there may be other (or different) reasons why simplifying mood analysis increases the system's accuracy and effectiveness. However, in implementations the system may be configured to differentiate between emotions at a more granular level, such as discerning between fear and anger, and having different approaches to such emotions.

In implementations the three affective qualities of valence, arousal, and alertness can be accurately detected/determined by a combination of biometrics, acoustic features and linguistic analysis, facial expressions and gestures, and body posture. In implementations the system may have minimal or no reliance on facial recognition because of the ability to use other inputs/data to determine valence, arousal and alertness.

Referring to Table 2 below, during observant driving, we want the driver to be cautious, but not apprehensive. In implementations the system and/or ML model may prioritize high alertness in this state, followed by neutral to slightly positive arousal, so that the emotional state of the driver is not too hyped and overreactive. In implementations valence in this state may be deprioritized as the least important quality, and may be neutral.

TABLE 2
Targets During Observant Driving

| | |
|---|---|
| Valence | 0 |
| Arousal | 0 |
| Alertness | +++ |

Referring to Table 3 below, during routine driving the system may attempt to put/keep the driver at ease. In such instances the system may prioritize positive valence, with neutral arousal, and a positive level of alertness, to ensure a safe drive.

TABLE 3
Targets During Routine Driving

| Valence | ++ |
|---|---|
| Arousal | 0 |
| Alertness | 0 |

Referring to Table 4 below, during effortless driving the system may attempt to keep/put the driver in a serene, relaxed state to let their mind wander. Stable emotions may help with this. The system may therefore attempt positive valence, coupled with neutral arousal and alertness.

TABLE 4
Targets During Effortless Driving

| Valence | + |
|---|---|
| Arousal | 0 |
| Alertness | 0 |

Referring to Table 5 below, during transitional driving the system may attempt to get/keep the driver excitedly looking forward to what comes next. The system may do this by focusing on highly positive valence, positive arousal, and neutral alertness.

TABLE 5
Targets During Transitional Driving

| Valence | +++ |
|---|---|
| Arousal | + |
| Alertness | 0 |

The above valence, arousal, and alertness targets are useful examples, but in implementations the system and/or ML model may have different targets for some of the above driving states. Table 6 below summarizes some example brainwave targets, emotion targets, and expected or hoped—for effects for the different states of driving.

TABLE 5
Summary of Example Targets and Effects for Driving States

| State of | Brainwave | Emotion Target | | | |
|---|---|---|---|---|---|
| Driving | Target | Valence | Arousal | Alertness | Effect |
| Obser- | Heightened | 0 | 0 | +++ | Cautious (not |
| vant | Perception | | | | apprehensive) |
| Routine | Alert | ++ | 0 | + | At ease |
| | Consciousness | | | | |
| Effort- | Physically & | + | 0 | 0 | Serene |
| less | Mentally | | | | |
| | Relaxed | | | | |
| Transi- | Excited | +++ | + | 0 | Forward |
| tional | Consciousness | | | | looking |

Once the context is determined, and the targets set or determined, the in-cabin systems and features can be utilized by the system 100 and/or ML model to either help reinforce the traveler's state of mind or intervene and correct it, as desired. For example, four types of applications/conditions which may influence a traveler's comfortable state of driving are: (1) drive assist applications; (2) applications/features related to physical conditions in the cabin; (3) infotainment content; and (4) details, features and/or configuration of a conversation agent.

With regards to drive assist applications, the vehicle industry has introduced self-parking, lane change warnings, rear cameras, etc., that reduce the stress of actual driving and make the driver more comfortable. Some such applications can be beneficial and/or should be used regardless of state of driving. Accordingly, in some instances the system and/or ML model may not adjust or affect drive assist applications. For example, whether a driver needs to be extra alert due to bad traffic or road conditions, or whether a driver can recharge their brain during a stretch of light steady traffic, safety should remain a priority. Even so, in some cases the system and/or ML model may affect or interact with drive assist features to affect brainwave and emotion targets—for example recommending that a user turn certain safety features on, or notifying the user when they have been turned off, or defaulting to automatically turning some safety features on, and so forth.

With regards to physical conditions, the in-cabin environment (such as in-cabin temperature, lighting, and noise) can have a great impact on a person's driving ability, creative thinking, and mood regulation. The Italian Association of Chemical Engineering published a landmark study in 2017 on the characteristics on Indoor Environment Quality (IEQ). The study divided the most important characteristics of IEQ into two parameters, one relating to energy that normally affects human physiology, and one influencing human psychology. The systems and methods disclosed herein may use both to affect comfortable driving, by using the disclosed reinforcements and interventions.

Another project called the “Hawthorne Studies,” run by the Harvard Business School for over 15 years, observed and interviewed more than 20,000 workers and defined what is called the Hawthorne effect: regardless of the nature of experimental manipulation employed by the researchers, work performance always increased. No matter what the researchers did, whether they increased or decreased lighting or temperature or humidity, productivity always appeared to improve. The explanation for these findings was that workers were responding to the attention that researchers paid to them, rather than changes to physical conditions in the workplace. In line with this, the systems and methods disclosed herein may alter physical conditions in a vehicle and pay attention to travelers' needs. Such findings may also be used to modify cabin designs.

Subsequent studies have indicated that they determined both the physiological and psychological effects of in-cabin physical conditions, and under which circumstances the optimal setting varies. Studies in both the automotive and office-work related fields suggest that there are six qualities in an environment's physical conditions that can help people move towards the respective ideal state: illumination (light and color); temperature; body position; acoustic control; humidity; and air quality.

With regards to illumination, the optimal illumination varies depending on the particular state of driving. The same light may be too dim or too bright, or have the wrong color, depending on the traveler's state of mind, gender, age, and/or other factors. The Industrial Ergonomists Henri Juslén and Ariadne Tenner indicated that beyond safety and visual comfort, the right lighting may also influence cognitive performance and problem-solving ability by interfering with circadian rhythms. The lighting and visibility expert Dr. Peter Boyce found that lighting can impact mood and interpersonal dynamics.

Another interesting aspect of lighting is its color. Multiple studies have confirmed that the ideal color depends on both age and gender. For instance, in a study conducted by University of Gavle's Igor Knez and Christina Kers, older adults showed a negative mood in cool bluish lighting, while younger adults (in their mid-20's) showed a more negative mood in warm, reddish light. Eindhoven University of Technology's Peter Mills and Susannah Tomkins found that fluorescent light sources with high correlated color temperature (17,000K) improved concentration, fatigue, alertness, performance, and mental health. Especially blue-enriched white light (17,000K) improved reduced daytime sleepiness and alertness.

It is useful to control lighting during early morning and nighttime driving to help the user stay awake and alert. Light mediates and controls a large number of biochemical processes in the human body, such as control of the biological clock and regulation of some hormones (such as cortisol and melatonin) through regular light and dark rhythms. It may be worthwhile experimenting on the possible effects or distraction of repeated brief exposures to bright light during dark drives.

During observant driving, brighter lighting (at about 1,200 lux) may be used to improve productivity and alertness. For routine driving there may be no special or desired lighting setting. During effortless driving, dimmer lighting (at about 800 lux) may be used to improve creative thinking. During transitional driving, lighting color may be selected to improve traveler mood, the selected/right color depending on traveler gender and age.

With regards to cabin temperature, the optimal cabin temperature can vary depending on the particular state of driving. Temperature can have a huge effect on human psychology and physical condition. The ergonomist Neville Stanton studied how temperature can affect workers' behavior and productivity. His studies of temperature and productivity found that temperature between 21-22° C. (70-72° F. will increase productivity, and as the temperature goes up between 23-24° C. (73-79° F.) productivity starts to relatively decrease.

The range of 21-23° C. (70-73° F.) is usually referred to as the ideal “room temperature.” However, when it comes to menial alert tasks (like driving through heavy traffic), warmer temperatures may increase focus and attention. A month-long office temperature study conducted by researchers at Cornell University at a major Florida insurance company, for instance, discovered fewer typing errors and higher productivity rates in employees working at 25° C. (77° F.). At this warm temperature, the researchers observed employees typing 100 percent of the time with a 10 percent error rate. Workers typed about 54 percent of the time with an error rate of 25 percent when the temperature was set to 20° C. (68° F.). One issue with cold temperatures is that they can be distracting, and if people are feeling cold they may use more energy to keep warm with less energy going towards concentration, inspiration and focus.

In some cases a warmer environment doesn't just make people more productive but also makes them genuinely happier. In a follow-up study, people were asked to rate the efficacy of heating pads or ice packs and then answer questions about their employer or a hypothetical company. Those who got their hands warm expressed higher job satisfaction and greater willingness to buy from and work at the made-up companies. The study hypothesized that the brain has difficulty differentiating physical sensations from psychological ones. This is interesting considering Yale Psychology professor John Bargh's research of the brain after cold and warm encounters: “The warmed subjects were also more likely than the cold ones to offer to a friend the prizes they received for participation, suggesting a possible overlap between the neural centers of trust and physical comfort.”

To some extent the brain doesn't seem to see a difference between physical warmth and psychological warmth. Warmer temperatures can improve one's mood, activate feelings of trust and empathy, and make people feel more welcoming. Bargh indicated that people who take long, hot showers or baths may do so to ward off feelings of loneliness or social isolation, hypothesizing that we can substitute social warmth, that we might be lacking on any given day, with physical warmth—the brain seeing little difference between the two. Such findings or hypotheses may be used to provide some inputs or default settings to the ML model and/or system, for example with regards to drives that involve role transitions and commutes home when the driver prepares to return to their family after a long stressful day at the office.

The issue of temperature becomes really interesting as the brain switches from simple focus to complex thinking, which often happens during the state of driving academics call “automaticity,” when the mind wanders and works on complex problems subconsciously. This may happen during effortless driving. During such effortless driving the system and/or ML model may control temperature in a way to support such mind wandering.

Ambient temperature can do more than influence productivity, but can also change the way people think. A study by University of Virginia's Amar Cheema and Vanessa Patrick showed that when students had to solve more complex problems that required abstract and creative thinking, they were able to do so twice as effectively in cool temperatures (19° C. or 66° F.) than in warm temperatures (25° C. or 77° F.).

Gender can come into play with regard to temperature as well. In temperature academia there is a rating called the Predicted Percentage of Dissatisfied (PPD). To calculate the PPD, most building managers use a standard 1960s formula, which takes into account factors such as the clothing and metabolic rate (how fast we generate heat) of a building's inhabitants. Tellingly, the latter requires a number of assumptions about their age, weight and, crucially, gender. The metabolic rate which currently controls the office thermostat is based on a 40-year-old, 70 kg man. Boris Kingma from Maastricht University Medical Center decided to take a closer look and found that women have significantly lower metabolic rates than men and need their offices 3° C. (5.4° F.) warmer. The discrepancy is explained in large part by the fact that women have fewer muscle cells and more fat cells, which are less active and produce less heat.

The systems and methods disclosed herein may use embedded technology already available in today's vehicles, or custom technology, to identify gender and adjust temperature, using higher temperatures when a woman is driving.

During observant driving, warmer temperatures (at or about 25° C./77° F.) may be used to improve productivity and alertness. During routine driving, the “ideal room temperature” (at or about 21-23T/70-73° F.) may be used to keep the traveler at ease. During effortless driving, cooler temperatures (at or about 19° C./66° F.) may be used to improve creative thinking. During transitional driving, warmer temperatures (at or about 25° C./77° F.) may be used to improve mood and help the traveler feel welcomed.

A traveler's body position can be related to their physical condition. The automotive industry has done some development in the area of body position in an attempt to optimize posture in the traveler's seat to improve blood circulation. This feature is not dependent on the type of drive, but may be useful during any type of trip.

With regards to acoustic control, extra noise can reduce focus and the ability to think creatively. It can also increase stress. Several vehicle manufacturers, most notably AUDI, have developed ambient noise controls that can mask the noise coming from outside the car. In certain driving situations that can be beneficial, like in effortless and transitional driving, where the focus lies beyond safety in subconscious thinking and mood regulation. However, in driving situations where safety is still the overwhelming priority, outside noises are necessary to help the driver orient themselves and understand the overall traffic conditions. The systems and methods disclosed herein may accordingly adjust noise cancelation features and/or audio level differently depending on the type of trip or driving type.

While good air quality and optimal humidity (between or about 40-60% relative humidity) are useful aspects of maintaining wellbeing in a vehicle, in implementations they may be maintained at constant levels rather than adapted to specific driving situations. In a study conducted by the University of Alberta's Psychology department, researchers found that out of eight weather variables (hours of sunshine, precipitation, temperature, wind direction, humidity, change in barometric pressure, and absolute barometric pressure), humidity was the best predictor of mood outcomes. On days when humidity was high, participants reported being less able to concentrate and feeling sleepier. They also found a link between high humidity and increased tiredness using controlled experimental methods. In contrast, participants reported increased pleasantness when in low humidity conditions. The systems and methods disclosed herein may adjust humidity to low levels to increase traveler mood, decrease sleepiness, and so forth.

The systems and methods disclosed herein may involve using scent as a possible intervention as well. Some research along these lines has shown potential (e.g., smelling peppermint may in implementations make a person more alert). However, in some implementations fragrance may have less of an impact on travelers than other physical conditions, so fragrance modification may be omitted in some systems and methods.

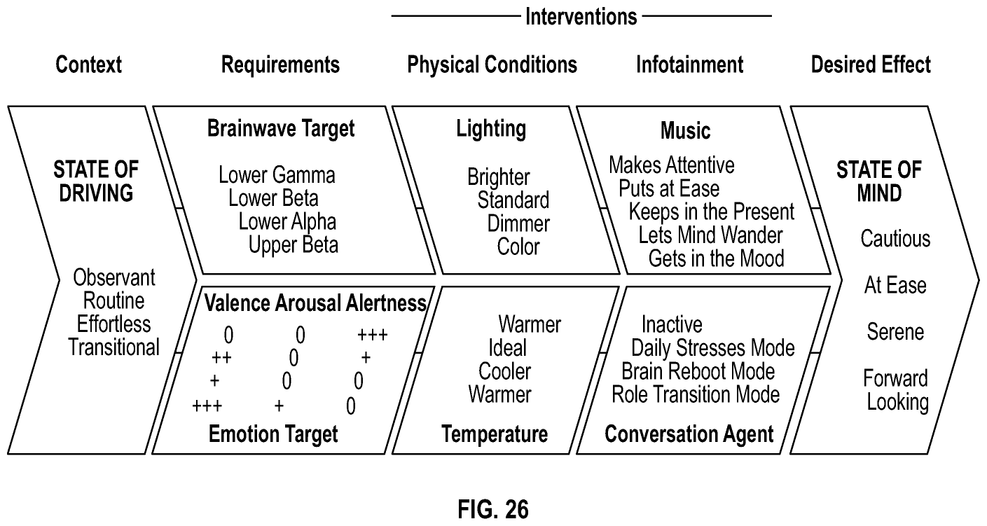

FIG. 26 representatively illustrates some of the concepts previously discussed. The various contexts or states of driving are shown on the left, including observant, routine, effortless, and transitional. The next “Requirements” column includes example brainwave targets and emotion targets for each state of driving. These are organized according to driving state—for example the brainwave target for observant driving is lower gamma, the brainwave target for routine driving is lower beta, and so forth. Similarly, the emotion target for effortless driving is valence +, arousal 0, alertness 0, while the emotion target for transitional driving is valence +++, arousal +, alertness 0. The Interventions columns include interventions related to physical conditions and infotainment. With regards to physical conditions, each of the four states of driving has a target lighting condition (brighter for observant, standard for routine, etc.). Each of the four states of driving has a target temperature (ideal for routine driving, cooler for effortless driving, etc.).

For the infotainment the music for the observant state of driving is selected o make the user attentive, while the music for the routine state of driving is selected to put the user at ease and keep them in the present. For effortless driving the music is selected to let the user's mind wander, and for the transitional driving state the music is selected to get the user in the mood for the next activity. A conversation agent may similarly be controlled/configured depending on the driving state, such as inactive during an observant driving state, in a “daily stresses” mode during routine driving, a brain reboot or mental reset mode during effortless driving, and a role transition mode during transitional driving. The desired effect, in terms of state of mind, for each driving state is given in the rightmost column, which includes cautious for observant driving, at ease for routine driving, serene for effortless driving, and forward looking for transitional driving.

The systems and methods disclosed herein help travelers feel better when they step out of a vehicle than when they got in by providing the right intervention (or an appropriate intervention) at the right time, in the right circumstance, for the right person, without command—making the systems and methods a responsive digital health experience. This improves wellbeing of the travelers and makes driving safer, easier, more fun, and more productive. Such systems and methods my utilize embedded sensor technology and location application programming interfaces (APIs), and other APIs, to deliver the physical and infotainment interventions. The systems and methods use empathetic AI, as discussed, by sensing, understanding, and effectively supporting a traveler during any state of driving. The systems and methods determine emotional dynamics in a vehicle and select appropriate interventions to modify or support certain emotional dynamics. This reduces traveler distress and increases traveler wellbeing, which may improve driving performance, creative thinking, safety, mood regulation, and environmental mastery.

As seen in FIG. 26, the ML model or empathetic AI of the system operates to the driver into the right state of mind. In each state of driving the system initiates different interventions (and different interventions based on the traveler's then state of mind or physical state) to improve traveler wellbeing. The provided infotainment and physical conditions are accordingly contextual, resulting in smart infotainment and physical condition alterations.

In implementations the context of each trip (or the driving state) is determined by the people in the vehicle (social dynamic and state of mind of travelers), the environment (trip progression and trip conditions), and the circumstances (trip intent and regularity of the trip). This is only one example—in implementations other factors may be used to determine the context of a trip, or some of these stated factors may be excluded.

The systems and methods disclosed herein include adaptive technology, attuned to trip conditions and social dynamics, and provide a responsive in-cabin experience automatically anticipating a traveler's needs and wants in any driving situation. Using empathetic AI and a vehicle's embedded sensors and other data sources to deliver the right interventions at the right time in the right circumstance for the right people. This helps the travelers drive safer, gets them in the right mood, and makes the trip more comfortable and enjoyable. The conversation agent can, using data gathered by the system, act as an empathetic confidante. An informational map may be displayed to the traveler and may involve the system's instinctive sense for the details of a given trip. Music may be fittingly synchronized to the trip's conditions, and may change the way users listen to music in a vehicle. The system develops an intimate relationship with the traveler(s) by flexibly adjusting, in real time, to the context for each listening occasion. Each playlist may be created to match the particular driving situation and may curate an appropriate song order and vibe progression, acting like a virtual DJ in the vehicle that knows how to read a room and respond to its vibe.

Due to the system's gathering of various types of data, the ML model and/or system may control or affect an empathetic conversation agent to act as a confidante. Instead of reducing a traveler's wellbeing during stressful trips, the traveler may thus drive profound benefit from trips. The conversation agent can use the gathered data to provide socially-aware conversation that focuses on supportive companionship rather than just assisting with tasks. The conversation agent may act as a virtual companion—the digital representation of a sidekick one seat over—and a traveler's main emotional support throughout a journey.

As indicated above, in implementations the system of FIG. 1 determines the state of driving to enable responsive in-cabin experiences, such as responsive infotainment (which may be described as infotainment with a high emotional quotient). The system, ML model or empathetic AI adapts the infotainment to each distinctive state of driving.

As an example of how the state of driving may determine the music, and referring to FIG. 7, when the vehicle is at or near position 701 the system may determine that the traveler is in a familiar city (routine driving), and may select music that keeps the driver balanced. This may involve selecting energy, approachability, engagement, and sentiment levels such as those in FIG. 18A (with high approachability and high engagement). When the vehicle is at or near position 702 the system may determine that the vehicle is on or near an empty highway (effortless driving), and may select music that lets the mind wander, such as using the levels of FIG. 18B with high approachability and low to mid engagement. When the vehicle is at or near position 703 the system may determine that the vehicle is at or near heavy traffic (observant driving), and may select music that helps the user to be attentive, such as using the levels of FIG. 18C with high engagement. When the vehicle is at or near position 704 the system may determine that the traveler is near a destination (transitional driving) and may select music that helps the traveler get in the mood for the next activity, such as using the levels of FIG. 18D with mid to high energy, mid to high approachability, mid to high engagement, and mid to high sentiment. These are only representative examples, and in implementations the system may select different music characteristics in various settings as preprogrammed or as the ML model of the system learns user preferences and/or what helps to achieve desired moods/emotions and/or brainwave targets of the user.

In implementations location APIs may be used to help determine the state of driving. There may be multiple states of driving during a single trip. In general it is expected that routine and observant driving states will be the predominant states for most drivers. In implementations routine is the default for all drives except the commute home.

In implementations observant becomes the default state if any one or more of the following occurs: traffic is orange or red (medium to heavy traffic—for example traffic averaging over 10 MPH below the speed limit); weather is bad (freezing temperatures, rain, snow, fog, heavy winds above a predetermined speed); it is a predetermined unusual time of day (early morning, late evening, night-time—for example any driving between 9 PM and 6 AM); the vehicle is speeding well above the speed limit (for example any speed more than 10 MPH above the speed limit); or several structural interruptions (toll stops, road work—for example averaging more than three stops or slow-downs within a ten mile stretch).

In implementations effortless driving may only be a portion of an overall trip and must meet all of a predetermined set of criteria, for example: the overall route/trip is longer than twenty minutes; the vehicle is on a highway or similar road; there are favorable traffic and road conditions (no traffic jams or structural interruptions); weather conditions are fair to good (e.g., no rain, no snow, no fog, temperature not below freezing, winds below a predetermined level); the drive is during daylight; and the user is in a portion of the trip with a steady speed (for example a ten-mile stretch of a highway with non-varying speed limit).

In implementations transitional driving is or becomes the default during a commute home unless observant criteria are met. Transitional driving may have predetermined time limitations in implementations—for example only kicking in during the final fifteen minutes of a transitional trip. Transitional driving may in implementations be defined as driving when the starting point and destination suggest a persona transition (e.g., work to home, work to restaurant, etc.).

With regards to the music compilation methods disclosed herein, there are additional details that may pertain to specific embodiments. In some implementations, after fifteen or more minutes (or some other predetermined amount of time) in yellow or red traffic (for example traffic averaging at least 10 MPH, or 20 MPH, respectively, below the speed limit), sentiment levels may be lowered to a “melancholy” state (for example playing emo genre of music) to elicit peacefulness and tenderness. In some implementations, during early mornings (for example 7 AM or earlier) and shortly before meetings (for example within 15 minutes of meetings, according to calendar entries), the engagement and energy levels of music may be raised by a predetermined amount (for example an increase of 20% in the energy level, as a non-limiting example). In some implementations, when a traveler is speeding more than 10% above the speed limit, the energy levels of the music are lowered (for example a decrease of 20% in energy level, as an example). Music modifications may be done during speeding to help the driver calm down and stop speeding or, on the other hand, to help them to be able to focus more attentively to driving during periods of speeding, in both cases for increased safety.

Modifications to levels of energy (which in some cases may be simply tempo), approachability, engagement, and sentiment may in some cases rely on predefined definitions. For example some predetermined tempo or energy may be predefined as zero energy, another predetermined tempo or energy may be predefined as 100% energy, and all tempos in between may then be categorized as some percentage of 100% (while tempos below the 0% threshold may still be considered 0% and tempos above the 100% tempo may still be considered 100%). Similar predeterminations may be made with respect to lowest and highest levels for energy (if it is defined as something other than tempo), approachability, engagement, and sentiment (or valence), with all levels in between then characterizable as some fraction of 100% of that characteristic. Thus, if the system is currently playing a song that is considered to have 50% energy level and the user is speeding, a 20% decrease in energy level may mean the system reduces the energy level to 30% (or alternatively a 20% decrease could mean a decrease by 20% of the 50%, which would mean a decrease down to a 40% energy level).

Location and other application programming interface (API) information that may be gathered by the system and/or used by the system for determining trip progression may include: the evolution of a trip including duration (or expected duration) of a trip vs. typical or average duration of prior trips on the same route, type(s) of roads, structural interruptions/notable markers (such as toll markers); traffic info (green, yellow, red, or for example traffic traveling at least the speed limit, traffic traveling 10+ miles per hour below the speed limit, and traffic traveling 20+ miles per hour below the speed limit); incidents and other criticalities along the trip route; a predefined jam factor (for traffic jams); and lane level traffic information. Other elements may be used to determine trip progression, and some of these may be excluded, as this is simply one example.

Location and other application programming interface (API) information that may be gathered by the system and/or used by the system for determining trip conditions may include: weather; time of day; and actual speed vs. speed limit. Other elements may be used to determine trip conditions, and some of these may be excluded, as this is simply one example.

Location and other application programming interface (API) information that may be gathered by the system and/or used by the system for determining trip intent may include a starting point and a destination. Other elements may be used to determine trip intent, and some of these may be excluded, as this is simply one example.

Displays visualizing a route (such as the example of FIG. 7) can include displays of speed limits, areas of congestion vs. open road (for example green for no or low traffic, orange for medium traffic, red for high traffic or congestion), elevation data, expected traffic delays, weather in general and weather along a route, a jam factor (basically a predetermined metric of how congested or jammed a stretch of road is vs. how freely traffic is flowing there, which may be determined by average current speed relative to speed limit, for example a factor of 0 may indicate no slowing and a jam factor of 10 may indicate a blocked roadway with no vehicle movement), traffic patterns, expected traffic patterns for hypothetical or future routes, a criticality factor related to road incidents (for example a metric used to show a level of criticality determined for specific upcoming road incidents, such as a several-car crash blocking multiple lanes having a very high level of criticality and a short one-lane blockage having a low criticality), lane level traffic (with knowledge of a “through” lane of traffic which is more open vs. a “congested” lane of traffic which vehicles are generally attempting to exit), and details regarding specific traffic and incident information along a corridor. Any of these items, even if not displayed on a display to a driver, may nevertheless be gathered and/or analyzed by the system to perform the disclosed methods and/or to inform the user about such information. Any such items of information may be gathered using APIs or by any other mechanism—for example a traffic routing API, a severe weather alert API, and so forth. In implementations the HERE routing API (an HTTP JSON REST API) may be used to provide route guidance, weather information, jam factors, and a variety of other details.

Referring to FIG. 3, it is pointed out that in implementations the communication chip can be used to receive weather data, traffic data, toll data, speed limit data, data regarding crashes, and so forth. Some data may be stored in memory as well, for later use, such as toll data, speed limit data, driving pattern data (regarding the driver currently driving, or vehicles in general, or any other driving pattern data), and so forth. It is further pointed out that the communication chip can include more than one chip. The communication chip and/or the vehicle sensors can include one or more NFC communication chips or devices to allow near-field communication(s) with nearby devices, such as smart phones, tablets, smart watches, and any other NFC-capable devices. The CPU and/or memory of FIG. 3, and/or the communication chip, may be used to provide data and instructions/control commands for drive assist features. These may be updated and/or adjusted over time, such as using machine learning which is trained over time using the patterns of a specific driver and vehicle and/or of a plurality of drivers and/or vehicles. The CPU and/or memory of FIG. 3 may also include code and/or instructions which, when executed by the CPU, control vehicle lighting, audio, temperature, humidity, air quality, in-vehicle fragrance release, and any other details or controls of an in-vehicle environment. Although not shown in FIG. 1 or 3, the system 100 may include, within or coupled to the vehicle, acoustic filters or other noise-reducing or noise-canceling elements, such as to reduce or cancel noise within (or entering) the cabin of a vehicle.

Referring to FIG. 8, in implementations selecting the fill-up selector may display only three options instead of a list of all gas stations. The three displayed options may be determined by the system based on factors such as proximity to the driver, cost, prior preferences input by the user, or prior preferences determined by the system based on the machine learning model using driving data of the user (such as which gas stations are frequented by the driver). Displaying three options is only one example, in some cases the system may show a limited number of options but fewer than three or greater than three. Displaying a limited number of options may be useful to help the user more quickly refuel (or acquire some other service or product) by helping the user make a quicker decision. While the fill-up selector is used as an example, the same method of limiting the number of options displayed may be applied to any of the other selectors of FIG. 8 (or other selectors discussed herein or in the drawings) such as vehicle charging stations, restaurants, coffee shops, supermarkets or grocery stores, shopping malls or department stores, and so forth. The system may accomplish this in part by providing one or more processors with details of multiple service providers corresponding with multiple locations. This correspondence can be based on a radius, for example—such as within one mile or a quarter mile of a freeway exit, or within a half mile of a GPS location, and so forth. Accordingly, service providers corresponding with a first location could be service providers within a predetermined radius of a freeway exit. On the other hand, the correspondence or correlation could be based on driving time, such that for example service providers corresponding with a first location are those that are within three minutes of a location (or some other amount of time). Service providers corresponding with a first location could also correspond with a second location, such as when the location radii or travel times overlap with one another. Accordingly, referring to FIG. 9, a service provider that is partway between a first and second exit on a freeway could be included in the list of providers shown for both exits, in some instances.

It is pointed out that the phrases emotional state and mental state are, in implementations, used interchangeably herein. The conversation agent may behave in a supportive and therapeutic manner, in implementations, by asking task-centric questions and emotion-centric questions to a traveler. Task-centric questions could include, for example, asking a traveler what they worked on today, or what they want to work on tomorrow. Emotion-centric questions can include, for example, asking the user how they feel about work today, or how they want to feel about work tomorrow.

As indicated herein, the disclosed systems and methods automatically provide contextual, personalized content and interventions to travelers tailored to specific circumstances and situations. Instead of vehicle time lowering the wellbeing of travelers and increasing their anxiety and stress, the vehicle is a refuge. No longer the most miserable activity in a person's day, time in the vehicle will instead be a refuge, an opportunity to release emotions the travelers wouldn't allow themselves anywhere else, so that when they step out of the car they feel more themselves, and healthier with greater wellbeing, then when they got in. A combination of sensor, diagnostic, and location API data may be used to determine the state of driving and tailor interventions and actions based on the driving state and the mental state of the traveler(s).

Any chatbot or conversational agent or other detail/characteristic of the systems and methods disclosed herein may include details or characteristics disclosed in: “The Strange, Nervous Rise of the Therapist Chatbot,” published online Aug. 16, 2022, available online at https://www.thedailybeast.com/chatbots-are-taking-over-the-world-of-therapy, last visited Feb. 8, 2023; “Detection and computational analysis of psychological signals using a virtual human interviewing agent,” A. A. Rizzo et al., published at Proc. 10th Intl Conf. Disability, Virtual Reality & Associated Technologies, 2-4 Sep. 2014, Gothenburg, Sweden; “Evaluation of driver stress level with survey, galvanic skin response sensor data, and force-sensing resistor data,” Daghan Dogan et al., Published in Advances in Mechanical Engineering 2019, Vol. 1 1(12) 1-19; “Unobtrusive Vital Sign Monitoring in Automotive Environments—A Review,” Steffen Leonhardt et al., published online Sep. 13, 2018, published in Sensors (Basel), 2018 September, 18(9): 3080; and “USC Institute for Creative Technologies: Virtual Humans,” published September 2013; each of which is incorporated herein by reference and each of which is disclosed in conjunction with an information disclosure statement associated with this application.

In implementations the systems and methods disclosed herein include the system choosing music therapeutically to either help the driver be more attentive (observant state), keep them in the present (routine state), let their mind wander (effortless state), or get them in the mood for what's coming next (transitional state). In implementations this is achieved by choosing music with specific settings of energy/arousal, engagement, approachability and sentiment.

In implementations during routine driving the system and/or methods may attempt to keep the driver in the desired mental state by using music which has mid-level energy, mid-level approachability, mid-level engagement, and mid-level valence (this music may in implementations help to keep the driver balanced). In implementations during effortless driving the system and/or methods may attempt to keep the driver in the desired mental state by using music which has low energy, high approachability, low engagement, and low valence (this music may in implementations help to driver's mind to wander). In implementations during observant driving the system and/or methods may attempt to keep the driver in the desired mental state by using music which has high energy, low approachability, high engagement, and high valence (this music may in implementations help the driver be and stay attentive). In implementations during transitional driving the system and/or methods may attempt to keep the driver in the desired mental state by using music which has high energy, high approachability, high engagement, and high valence (this music may in implementations help to get the driver in the mood for the next activity).

In places where the phrase “one of A and B” is used herein, including in the claims, wherein A and B are elements, the phrase shall have the meaning “A or B.” This shall be extrapolated to as many elements as are recited in this manner, for example the phrase “one of A, B, and C” shall mean “A, B, or C,” and so forth.

In places where the description above refers to specific embodiments of vehicle systems and interfaces and related methods, one or more or many modifications may be made without departing from the spirit and scope thereof. Details of any specific embodiment/implementation described herein may, wherever possible, be applied to any other specific implementation/embodiment described herein.

What is claimed is:

1. A vehicle method, comprising:
providing one or more computer processors communicatively coupled with a vehicle;
using the one or more computer processors, determining a mental state of a driver based at least in part on data gathered from one of biometric sensors and vehicle sensors;
using the one or more computer processors and based at least in part on one or more details of a trip, determining one of a plurality of predetermined driving states corresponding with at least a portion of the trip; and
using the one or more computer processors, and based at least in part on the determined mental state and the determined driving state, automatically initiating one or more interventions configured to alter the mental state of the driver.

2. The method of claim 1, wherein the plurality of predetermined driving states comprises observant driving, routine driving, effortless driving, and transitional driving.

3. The method of claim 2, further comprising the one or more processors determining that at least a portion of the trip comprises observant driving in response to a detection or determination that one or more of the following are present or upcoming: a traffic slowdown of a predetermined threshold below a speed limit; a calculated traffic jam factor beyond a predetermined threshold; rain; snow; fog; wind speed above a predetermined threshold; temperature beyond a predetermined threshold; driving between a predetermined time range; driving during a predetermined rush hour time range; driving a threshold amount beyond a speed limit; a structural obstruction; a toll location; light conditions beyond a predetermined threshold; a driving location the driver has not previously traversed; and a driving location the driver has traversed below a predetermined amount of times.

4. The method of claim 2, further comprising the one or more processors determining that at least a portion of the trip comprises routine driving in response to a detection or determination that one or more of the following are present or upcoming: a total estimated travel time below a predetermined time limit; a driving location the driver has previously traversed; a driving location the driver has previously traversed a threshold number of times; a total trip mileage below a predetermined threshold; mileage of a portion of the trip being below a predetermined threshold; time of a portion of the trip being below a predetermined threshold; a commute to work; absence of rain; absence of snow; absence of fog; wind speed below a predetermined threshold; light conditions beyond a predetermined threshold; and a drop off of a passenger.

5. The method of claim 2, further comprising the one or more processors determining that at least a portion of the trip comprises effortless driving in response to a detection or determination that one or more of the following are present or upcoming: a commute having an expected mileage above a predetermined threshold; a commute having an expected travel time above a predetermined threshold; traveling on a highway; traveling on a freeway; traveling on an interstate; a total expected travel time beyond a predetermined amount of time; expected travel time for a trip portion being beyond a predetermined amount of time; a driving location the driver has previously traversed; a driving location the driver has previously traversed a threshold number of times; a vacation-related trip; an absence of a traffic slowdown of a predetermined threshold below a speed limit; a calculated traffic jam factor within a predetermined threshold; an absence of structural obstructions; a lack of toll locations; absence of rain; absence of snow; absence of fog; temperature above a predetermined threshold; temperature within a predetermined range; temperature below a predetermined threshold; wind speed below a predetermined threshold; light conditions beyond a predetermined threshold; driving within a predetermined time range; a consistent speed limit for a predetermined amount of time or mileage; and driving outside of a predetermined rush hour time range.

6. The method of claim 2, further comprising the one or more processors determining that at least a portion of the trip comprises transitional driving in response to a detection or determination that one or more of the following are present or upcoming: a commute home; an estimated amount of time, to a determined end location from a present location, below a predetermined threshold; an estimated amount of mileage, to a determined end location from a present location, below a predetermined threshold; and a determination of a different activity type at the end location relative to an activity type at a starting location.

7. The method of claim 2, further comprising the one or more processors defaulting to the routine driving state unless one or more characteristics of observant driving, effortless driving, or transitional driving are detected or determined, or unless a commute home is detected or determined.

8. A vehicle machine learning method, comprising:
providing one or more computer processors communicatively coupled with a vehicle;
using data gathered from one of biometric sensors and vehicle sensors, training a machine learning model to determine a mental state of a driver;
determining the mental state of the driver using the trained machine learning model;
using the one or more computer processors and based at least in part on one or more details of a trip, determining one of a plurality of predetermined driving states corresponding with at least a portion of the trip; and
using the one or more computer processors, and based at least in part on the determined mental state and the determined driving state, automatically initiating one or more interventions configured to alter the mental state of the driver.

9. The method of claim 8, wherein the one or more computer processors determines the driving state based at least in part on a location of the vehicle.

10. The method of claim 8, wherein the plurality of predetermined driving states includes observant driving, routine driving, effortless driving, and transitional driving.

11. The method of claim 8, wherein the one or more interventions includes changing an environment within a cabin of the vehicle.

12. The method of claim 11, wherein the one or more interventions includes one of altering a lighting condition within the cabin, altering an audio condition within the cabin, and altering a temperature within the cabin.

13. The method of claim 8, wherein the one or more interventions includes one of preparing a music playlist and altering the music playlist, and wherein the one or more interventions further includes initiating the music playlist.

14. The method of claim 8, wherein the one or more interventions includes selecting music for playback within the cabin.

15. The method of claim 14, wherein the one or more computer processors select the music based at least in part on an approachability of the music, an engagement of the music, a sentiment of the music, and one of an energy of the music and a tempo of the music.

16. The method of claim 8, wherein the one or more interventions includes one of initiating, altering, and withholding interaction between the driver and a conversational agent.

17. The method of claim 8, wherein training the machine learning model to determine the mental state of the driver includes training the machine learning model to determine one of a valence level, an arousal level, and an alertness level of the driver.

18. The method of claim 8, wherein initiating the one or more interventions to alter the mental state of the driver comprises initiating one or more interventions to alter one of a valence level, an arousal level, and an alertness level of the driver.

19. A vehicle machine learning system, comprising:
one or more computer processors; and
one or more media storing instructions executable by the one or more processors, wherein the instructions, when executed, cause the vehicle machine learning system to perform operations comprising:
training a machine learning model to determine one of a plurality of predetermined driving states corresponding with at least a portion of a trip;
determining one of the predetermined driving states corresponding with at least a portion of the trip using the trained machine learning model;
based at least in part on data gathered from one of biometric sensors and vehicle sensors, determining a mental state of a driver; and
based at least in part on the determined mental state and the determined driving state, automatically selecting and initiating one or more interventions configured to alter the mental state of the driver.

20. The system of claim 19, wherein the one or more interventions is selected based at least in part on a target brainwave frequency.
